(19) United States
(12) Patent Application Publication
(10) Pub. No.: US 2026/0259485 A1
(43) Pub. Date: Sep. 3, 2026

(54) BILINGUAL AUGMENTED REALITY LAMP WITH INTERACTIVE LANGUAGE SWITCHING FEATURES

(71) Applicant: MonPetitWorld LLC, Sherman Oaks, CA (US)

(72) Inventor: Mayelice Castro FIL, Sherman Oaks, CA (US)

(73) Assignee: MonPetitWorld LLC, Sherman Oaks, CA (US)

(21) Appl. No.: 19/544,954

(22) Filed: Feb. 19, 2026

Related U.S. Application Data
(60) Provisional application No. 63/761,854, filed on Feb. 21, 2025.

(51) Int. Cl. G03B 29/00; G03B 30/00; G06F 3/16; G06K 7/14; G06V 30/14; G06V 30/244; G06V 30/28; H04N 13/363

(52) U.S. Cl. CPC G03B 29/00; G03B 30/00; G06F 3/167; G06K 7/1417; G06K 7/1447; G06V 30/1431; G06V 30/2445; G06V 30/28; H04N 13/363

(57) ABSTRACT

Systems and methods for implementing a bilingual augmented reality lamp assembly for use with a book are disclosed. A bilingual augmented reality lamp assembly can include a lamp stem coupled to a reading surface, a lamp head coupled to the lamp stem, a camera coupled to the lamp head, and one or more processors configured to identify, based on images captured by the camera, content included on the page of the book, process the content using one or more models, and determine, based on the one or more models, the content corresponds to textual content in a first language or visual content. The one or more processors can provide, using at least one output device, an output including audio signals including a translation of the textual content in a second language or an augmented reality projection of the translation or the visual content in visual proximity to the book.

### CROSS-REFERENCE TO RELATED PATENT APPLICATIONS

This application claims the benefit of and priority to U.S. Provisional Application No. 63/761,854, filed Feb. 21, 2025, the contents of which are incorporated by reference herein in its entirety and for all purposes.

### BACKGROUND

Some computer-based or digital tools can facilitate language learning and literacy development, particularly for children and multilingual learners. Reading materials such as books often include text and illustrations that convey information in a single language. However, accessing equivalent content in multiple languages or enhancing reading experiences with interactive elements presents various technical challenges.

### SUMMARY

This disclosure relates to techniques for providing bilingual learning experiences through augmented reality projection systems integrated with reading lamps. Educational tools for language learning often include printed books or electronic displays that present content in a single language at a time. Conventional approaches to multilingual education typically require separate physical books in different languages or electronic devices with screens that display translated text. Physical bilingual books can be costly to produce and distribute, while screen-based electronic learning devices can cause eye strain during extended reading sessions and may raise privacy concerns when connected to external networks. For children learning to read in multiple languages, conventional systems often fail to provide synchronized audio and visual feedback that aligns with the physical page of a book. Optical character recognition (OCR) systems have been developed to scan printed text, but conventional OCR-based translation systems typically require internet connectivity to access remote translation services, which can introduce latency and expose user data to external servers. Furthermore, existing augmented reality systems for educational purposes often rely on wearable devices such as smart glasses or handheld devices such as tablets, which can be cumbersome for young children and may not provide a natural reading experience with physical books.

The techniques described herein provide approaches for integrating augmented reality projection, local artificial intelligence processing, and bilingual audio output into a lamp assembly that can be positioned above a physical book. To do so, the techniques described herein can employ a camera to capture images of a book page, a local processor to perform OCR and translation using on-device language models, and a projector to display augmented reality content directly onto the book page without requiring external network connectivity. The lamp assembly can include a limited number of physical control inputs, such as a power button and a language selection button, to provide a simplified user interface suitable for children. In some implementations, the techniques described herein can provide audio feedback in a selected language through integrated speakers, while simultaneously projecting visual augmented reality content such as translated text or animated illustrations onto the book page. The local processing approach can preserve user privacy by avoiding transmission of captured images or reading data to external servers. The lamp assembly can be configured in a foldable or portable form factor, and can include a rechargeable battery to support wireless operation. By combining optical scanning, local translation processing, and synchronized audio-visual output in a single lamp device, the techniques described herein can provide an immersive bilingual reading experience that does not require screens, internet connectivity, or complex user interactions.

In some aspects, the techniques described herein relate to a bilingual augmented reality lamp assembly for use with a book, including: a lamp stem coupled to a reading surface, the reading surface configured to receive the book; a lamp head coupled to the lamp stem and configured to be positioned above the reading surface; a camera coupled to the lamp head and configured to capture images of a page of the book; at least one output device; one or more processors coupled with memory and configured to: identify, based on the images captured by the camera, content included on the page of the book; process the content using one or more models; determine, based on the one or more models, the content corresponds to at least one of textual content in a first language or visual content; and provide, using the at least one output device, an output including at least one of: audio signals including a translation of the textual content in a second language; or an augmented reality projection of the translation of the textual content in the second language or the visual content in visual proximity to the page of the book.

In some aspects, the techniques described herein relate to a bilingual augmented reality lamp assembly, wherein the first language is different from the second language, and wherein the first language and the second language are selected from English, French, and Spanish.

In some aspects, the techniques described herein relate to a bilingual augmented reality lamp assembly, wherein the at least one output device includes a projector configured to project the augmented reality projection and a speaker configured to provide the audio signals including the translation of the textual content in the second language.

In some aspects, the techniques described herein relate to a bilingual augmented reality lamp assembly, further including: a first input element for powering up or powering down the bilingual augmented reality lamp assembly, and a second input element for switching between a plurality of languages for the output, the plurality of languages including at least the first language, the second language, and a third language.

In some aspects, the techniques described herein relate to a bilingual augmented reality lamp assembly, wherein the one or more processors locally process the content included on the page of the book using optical character recognition and a language dictionary.

In some aspects, the techniques described herein relate to a bilingual augmented reality lamp assembly, further including: a light source coupled to the lamp head, the light source configured to illuminate at least a portion of the page of the book; and at least one input element configured to activate or deactivate the light source.

In some aspects, the techniques described herein relate to a bilingual augmented reality lamp assembly, further including: a battery configured to supply power to at least the camera, the at least one output device, and the one or more processors; and a power supply input configured to provide electrical signals to charge the battery.

In some aspects, the techniques described herein relate to a bilingual augmented reality lamp assembly, wherein the one or more processors are configured to: provide, using the at least one output device, a first output including audio signals of the textual content in the first language; and responsive at least in part to an input selecting the second language, provide, using the at least one output device, a second output including the audio signals of the textual content in the second language.

In some aspects, the techniques described herein relate to a bilingual augmented reality lamp assembly, further including a microphone configured to receive voice commands from a user.

In some aspects, the techniques described herein relate to a bilingual augmented reality lamp assembly, wherein the one or more processors are configured to: provide, using the at least one output device, the content included on a line of the page by providing the audio signals corresponding to the textual content of the line of the page and projecting the augmented reality projection associated with the line of the page.

In some aspects, the techniques described herein relate to a bilingual augmented reality lamp assembly, wherein the one or more processors are configured to: determine a user has completed reading of the page of the book; and provide a second output including audio signals prompting the user to turn the page of the book.

In some aspects, the techniques described herein relate to a bilingual augmented reality lamp assembly, wherein the one or more processors are configured to: detect boundaries of the page based on the images captured by the camera; and align the augmented reality projection within the boundaries of the page.

In some aspects, the techniques described herein relate to a bilingual augmented reality lamp assembly, wherein the one or more processors are configured to: detect, using the camera, a machine-readable code on at least a portion of the book; determine an identifier of the book based on the machine-readable code; and access the translation of the textual content in the second language from a language dictionary based on the identifier of the book.

In some aspects, the techniques described herein relate to a bilingual augmented reality lamp assembly, wherein the one or more processors are configured to protect privacy of a user by processing the content using the one or more models without transmitting or receiving data from an external network.

In some aspects, the techniques described herein relate to a bilingual augmented reality lamp assembly, wherein the reading surface forms a portion of the bilingual augmented reality lamp assembly, and wherein the bilingual augmented reality lamp assembly is configurable between: a folded configuration in which the lamp stem is folded; and an extended configuration in which the lamp stem is extended.

In some aspects, the techniques described herein relate to a bilingual augmented reality lamp assembly, wherein the reading surface is separate from the bilingual augmented reality lamp assembly, and wherein the bilingual augmented reality lamp assembly includes a mechanical clip or clamp configured to secure the lamp stem and the lamp head to the reading surface.

In some aspects, the techniques described herein relate to a bilingual augmented reality lamp assembly, wherein the one or more processors are configured to: detect, from the content, at least one entity selected from animals, people, objects, wherein the content indicates the at least one entity performing an action; and generate the augmented reality projection using the images captured from the page, a pre-stored visual asset, or an AI-generated visual asset, wherein the augmented reality projection includes motion corresponding to the action performed by the at least one entity.

In some aspects, the techniques described herein relate to a bilingual augmented reality lamp assembly, wherein the one or more processors are configured to: responsive to an input selecting the second language, cause the at least one output device to provide an audio signal indicating the second language is selected for the output.

In some aspects, the techniques described herein relate to a method, including: capturing, by one or more processors, coupled with memory, using a camera coupled to a bilingual augmented reality lamp assembly, images of a page of a book positioned on a reading surface; identifying, by the one or more processors, based on the images captured by the camera, content included on the page of the book; processing, by the one or more processors, the content using one or more models; determining, by the one or more processors, based on the one or more models, the content corresponds to at least one of textual content in a first language or visual content; and providing, by the one or more processors, using at least one output device coupled to the bilingual augmented reality lamp assembly, an output including at least one of: audio signals including a translation of the textual content in a second language; or an augmented reality projection of the translation of the textual content in the second language or the visual content in visual proximity to the page of the book.

In some aspects, the techniques described herein relate to a non-transitory computer-readable storage medium (CRM) having one or more instructions stored thereon, the one or more instructions executable by one or more processors to: capture, using a camera coupled to a bilingual augmented reality lamp assembly, images of a page of a book positioned on a reading surface; identify, based on the images captured by the camera, content included on the page of the book; process the content using one or more models; determine, based on the one or more models, the content corresponds to at least one of textual content in a first language or visual content; and provide, using at least one output device coupled to the bilingual augmented reality lamp assembly, an output including at least one of: audio signals including a translation of the textual content in a second language; or an augmented reality projection of the translation of the textual content in the second language or the visual content in visual proximity to the page of the book.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a perspective view of a bilingual augmented reality lamp in an extended configuration;

FIG. 2 is a perspective view of an augmented reality lamp moving from an extended configuration to a folded configuration;

FIG. 3 is a perspective view of an augmented reality lamp moving from an extended configuration to a folded configuration;

FIG. 4 is a schematic view of a bilingual augmented reality lamp positioned to illuminate and project an augmented reality projection onto an open book;

FIG. 5 is a schematic view of a bilingual augmented reality lamp projecting multilingual text and animated visuals onto an open book page;

FIG. 6 is a perspective view of a bilingual augmented reality lamp in which the reading surface is separate therefrom and attached using a clamp or clip mechanism;

FIG. 7 is a bottom perspective view of a bilingual augmented reality lamp including a control interface, optical elements, auditory elements, and computing devices;

FIG. 8 is a perspective view of a control interface of a bilingual augmented reality lamp;

FIG. 9 is a block diagram illustrating components of a data processing system for controlling an augmented reality lamp with bilingual language switching and audio/visual outputs; and

FIG. 10 is a flowchart illustrating a method for operating a bilingual augmented reality lamp.

### DETAILED DESCRIPTION

Below are detailed descriptions of various concepts related to, and approaches, methods, apparatuses, and systems for implementing the various techniques described herein. The various concepts introduced above and discussed in greater detail below may be implemented in any of numerous ways, as the described concepts are not limited to any particular manner of implementation. Examples of specific implementations and applications are provided primarily for illustrative purposes.

This disclosure relates to techniques for providing bilingual learning experiences through augmented reality projection systems integrated with reading lamps. Educational tools for language learning often include printed books or electronic displays that present content in a single language at a time. Conventional approaches to multilingual education typically require separate physical books in different languages or electronic devices with screens that display translated text. Physical bilingual books can be costly to produce and distribute, while screen-based electronic learning devices can cause eye strain during extended reading sessions and may raise privacy concerns when connected to external networks. For children learning to read in multiple languages, conventional systems often fail to provide synchronized audio and visual feedback that aligns with the physical page of a book. Optical character recognition (OCR) systems have been developed to scan printed text, but conventional OCR-based translation systems typically require internet connectivity to access remote translation services, which can introduce latency and expose user data to external servers. Furthermore, existing augmented reality systems for educational purposes often rely on wearable devices such as smart glasses or handheld devices such as tablets, which can be cumbersome for young children and may not provide a natural reading experience with physical books.

However, conventional approaches to bilingual learning present several technical challenges. Systems that rely on separate physical books for different languages require users to maintain multiple copies of the same content, which can be impractical and expensive. Screen-based translation systems can cause eye fatigue during prolonged use, particularly for children. Existing OCR and translation systems that depend on external network connectivity can introduce latency between scanning text and displaying translated content, which can disrupt the reading experience. The reliance on external servers for translation processing can also raise privacy concerns, as captured images of book pages and reading data may be transmitted to remote systems. Augmented reality systems that require wearable devices or handheld electronics can be complex to operate for young children and may distract from the physical book reading experience. Conventional approaches also fail to provide synchronized audio narration in multiple languages while simultaneously projecting visual augmented reality content aligned with the physical page of a book.

The techniques described herein provide approaches for integrating augmented reality projection, local artificial intelligence processing, and bilingual audio output into a lamp assembly that can be positioned above a physical book. To do so, the techniques described herein can employ a camera to capture images of a book page, a local processor to perform OCR and translation using on-device language models, and a projector to display augmented reality content directly onto the book page without requiring external network connectivity. The lamp assembly can include a limited number of physical control inputs, such as a power button and a language selection button, to provide a simplified user interface suitable for children. In some implementations, the techniques described herein can provide audio feedback in a selected language through integrated speakers, while simultaneously projecting visual augmented reality content such as translated text or animated illustrations onto the book page.

To implement the techniques described herein, a lamp assembly can include a camera positioned on an underside of a lamp head to capture images of a book page placed beneath the lamp. The captured images can be processed by one or more processors using optical character recognition to extract textual content from the page. The extracted text can be processed using one or more language models stored locally on the lamp assembly to generate translations in a selected target language. The lamp assembly can include a projector positioned on the underside of the lamp head to project augmented reality content onto the book page, such that the projected content aligns with the physical layout of the page. The projected content can include translated text in the target language, visual representations of objects or characters described in the text, or animated elements corresponding to actions described in the text. The lamp assembly can include one or more speakers to provide audio output, such as narration of the text in the selected language or audio feedback indicating the currently selected language. The lamp assembly can include physical input elements, such as a power button and a language selection button, to receive user inputs. The processing of images, text extraction, translation, and generation of augmented reality content can be performed locally on the lamp assembly without transmitting data to external servers.

By combining optical scanning, local translation processing, and synchronized audio-visual output in a single lamp device, the techniques described herein can provide an immersive bilingual reading experience that does not require screens, internet connectivity, or complex user interactions. The local processing approach can preserve user privacy by avoiding transmission of captured images or reading data to external servers, addressing privacy concerns associated with conventional cloud-based translation systems. In some examples, the integration of a projector to display augmented reality content directly onto the book page can eliminate the need for separate screens or wearable devices, reducing latency associated with multi-device operation, reducing eye strain, and providing a more natural reading experience. The synchronized provision of audio narration and visual augmented reality projections can provide reinforcement for language learning, such that children can associate spoken words with written text and visual representations simultaneously. The use of a streamlined voice-based or physical control interface can make the lamp assembly accessible to young children without requiring complex menu navigation or touchscreen interactions. The portable and rechargeable form factor can allow the lamp assembly to be used in various locations without requiring connection to external power sources or network infrastructure, providing a technical improvement over existing approaches to bilingual learning.

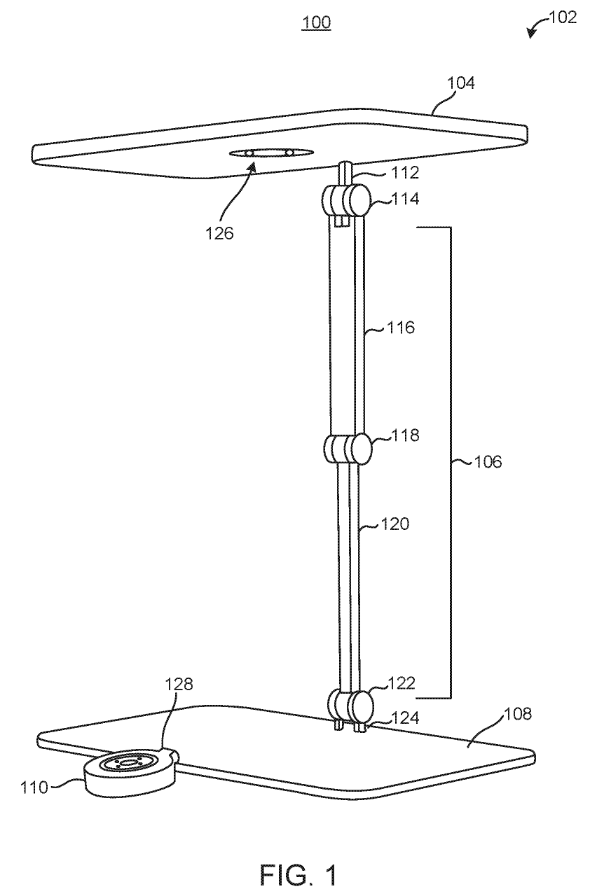

Referring now to FIG. 1, illustrated is a perspective view 100 of a bilingual augmented reality lamp assembly 102 in an extended configuration. The lamp assembly 102 can include a lamp head 104, a stem assembly 106, a reading surface 108, a control interface 110, optical elements 126, and a plurality of couplings 112, 124, 128 and joints 114, 118, 122 coupling various components of the lamp assembly 102. The stem assembly 106 can include a first link 116 and a second link 120.

The lamp assembly 102 can be a bilingual augmented reality lamp assembly for use with a book. The lamp assembly 102 can be an integrated device that combines physical illumination components with augmented reality projection capabilities and bilingual language processing features. For example, the lamp assembly 102 can include a smart lamp design with embedded augmented reality technology that provides dynamic lighting effects while engaging with bilingual content such as instructions, labels, and/or text in multiple languages. The lamp assembly 102 can display content in multiple languages with initial support for English, French, and Spanish, and can provide augmented reality projections of translated text and/or visual content in visual proximity to pages of books. In some implementations, the lamp assembly 102 can process content from a book page using optical character recognition and one or more language models stored locally on the device to generate translations without requiring external network connectivity. That is, the lamp assembly 102 can execute text recognition algorithms and translation algorithms using processing components and memory housed within the lamp assembly 102, such that captured images of book pages are converted to translated text and augmented reality projections without transmitting data to external servers. The lamp assembly 102 may be configured in a foldable form factor with a rechargeable battery to support wireless operation in various locations. The lamp assembly 102 may include non-toxic materials that prevent sharp edges and/or small detachable parts, and may provide eye-safe lighting with adjustable brightness meeting international child safety standards.

The lamp assembly 102 can include a lamp head 104. The lamp head 104 can be a housing structure positioned at an upper portion of the lamp assembly 102 that contains various optical, electronic, and projection components. That is, the lamp head 104 can form an enclosure that houses functional subsystems used for image capture, augmented reality projection, and audio output. For example, the lamp head 104 can include a compact housing that encloses a camera, a projector, light sources, and processing components used to capture images of book pages and project augmented reality content. The lamp head 104 can include various shapes. For example, as illustrated on FIG. 1, the lamp head 104 can include a rectangular shape with rounded edges. In other examples, the lamp head 104 can include other shapes, such as a circular shape, an oval shape, or a square shape, among others.

The lamp head 104 can be configured to be positioned above a reading surface to allow the camera and projector contained within the lamp head 104 to operate on books placed beneath the lamp assembly 102. That is, the lamp head 104 can maintain a spatial relationship with the reading surface such that optical elements within the lamp head 104 can capture images of book pages and project visual content onto those pages. In some implementations, the lamp head 104 can house optical elements that perform scanning and projection functions for augmented reality features. The lamp head 104 may be coupled to the stem assembly through a coupling that allows angular adjustment or repositioning of the lamp head 104 relative to the reading surface. That is, the lamp head 104 can be rotated, tilted, or otherwise moved through articulation of the coupling to change the viewing angle or projection angle relative to books placed on the reading surface. In some implementations, the lamp head 104 may include ventilation features or heat dissipation structures to manage thermal output from the projector and processing components contained within the housing. For example, the lamp head 104 can include vents, heat sinks, or thermally conductive pathways that transfer heat generated by light sources, image sensors, and processors to the external environment to prevent overheating during extended operation.

The lamp assembly 102 can include a stem assembly 106 (e.g., lamp stem). The stem assembly 106 can be a structural element that extends between the lamp head 104 and the reading surface 108 to provide vertical positioning and support for the lamp head 104. That is, the stem assembly 106 can maintain a spatial relationship between the lamp head 104 and the reading surface 108 such that the lamp head 104 is positioned at a working height above the reading surface 108 where the camera and projector housed in the lamp head 104 can operate on books placed on the reading surface 108. For example, the stem assembly 106 can include one or more rigid links, semi-rigid links, telescoping segments, or articulated segments that extend vertically or at an angle between the lamp head 104 and the reading surface 108. The stem assembly 106 can maintain a desired spatial relationship between the lamp head 104 and the reading surface 108 during operation by resisting deflection under the weight of the lamp head 104 and any forces applied during user interaction with the lamp assembly 102. In some implementations, the stem assembly 106 can include one or more rigid or semi-rigid links that maintain a desired spatial relationship between the lamp head 104 and the reading surface 108 during operation. The stem assembly 106 can couple the lamp head 104 to the reading surface 108 through a series of joints and links that allow the lamp assembly 102 to be configured in different positions. That is, the stem assembly 106 can include multiple articulated segments connected by pivot joints, hinge joints, ball-and-socket joints, or other rotational couplings that permit angular adjustment of the lamp head 104 relative to the reading surface 108. In some examples, the stem assembly 106 can include a fixed stem without such articulated segments or with fewer articulated segments (e.g., a single fixed portion allowing adjustment or tilting between the lamp head 104 and the stem assembly 106, and/or between the reading surface 108 and the stem assembly 106).

In some implementations, the stem assembly 106 can allow the lamp assembly 102 to transition between a folded configuration in which the stem assembly 106 is collapsed and an extended configuration in which the stem assembly 106 is extended to position the lamp head 104 at a working height above the reading surface 108. The folded configuration can reduce the overall height or volume of the lamp assembly 102 to facilitate storage or transport. The extended configuration can position the lamp head 104 at a height that allows the camera to capture images of book pages and the projector to display augmented reality content on those pages without obstruction. The stem assembly 106 may include internal channels or routing pathways for electrical conductors that transmit power and/or data signals between components in the lamp head 104 and components in or near the reading surface 108 (e.g., input signals from the control interface 110 or power signals from a charging port). The stem assembly 106 may provide sufficient mechanical stiffness to resist deflection under the weight of the lamp head 104 while allowing controlled articulation through the joints. That is, the stem assembly 106 can be constructed from materials such as aluminum alloys, steel alloys, reinforced polymers, or composite materials that provide structural rigidity to prevent sagging or bending of the lamp head 104 when the lamp assembly 102 is in the extended configuration, while also permitting rotation or angular displacement at the joints when users apply force to reposition the lamp head 104 or transition the lamp assembly 102 between the folded configuration and the extended configuration.

The lamp assembly 102 can include a reading surface 108. The reading surface 108 can be a planar or substantially planar element configured to receive and support a book during reading operations. For example, the reading surface 108 can include a horizontal platform with sufficient surface area to accommodate open books of various sizes while maintaining stability during page turning and interaction. The reading surface 108 can be coupled to the stem assembly 106 and can provide a stable base for the lamp assembly 102 during operation. In some implementations, the reading surface 108 can form a portion of the lamp assembly 102 in an integrated design where the stem assembly 106 is permanently or semi-permanently attached to the reading surface 108. The reading surface 108 may include surface treatments or materials that provide friction to prevent books from sliding during use. The reading surface 108 may include reference markings or guides to assist with book positioning. The reading surface 108 may be shaped to provide a compact footprint that occupies minimal desk space while maintaining sufficient area to support books in an open configuration. In some implementations, the reading surface 108 can include non-skid elements or feet on a bottom surface that prevent the lamp assembly 102 from sliding on desks or tables during use. The reading surface 108 may be removably coupled to the stem assembly 106 through mechanical fasteners, magnetic attachments, or snap-fit connections. The reading surface 108 may be constructed from materials selected for child-safe design requirements, such as non-toxic plastics, metals with rounded edges, or impact-resistant composites that prevent injury during handling or accidental impacts.

The lamp assembly 102 can include a control interface 110. The control interface 110 can be a user input mechanism that receives physical inputs from users to control operation of the lamp assembly 102. That is, the control interface 110 can receive actuation signals from physical input elements and transmit corresponding control signals to processing components of the lamp assembly 102. For example, the control interface 110 can include a first input element for powering up or powering down the lamp assembly 102 and a second input element for switching between a plurality of languages for output. The control interface 110 can receive user inputs to activate or deactivate the lamp assembly 102 and to select between multiple languages such as English, French, and Spanish. In some implementations, the control interface 110 can be positioned on a bottom surface of the reading surface or on another accessible location of the lamp assembly 102 to provide simple access to power and language selection functions. The control interface 110 may include physical buttons, switches, or touch-sensitive elements that provide tactile feedback when activated by users. The control interface 110 may be coupled to one or more processors that interpret inputs from the control interface 110 and execute corresponding control operations such as changing language settings or powering components on or off. In some implementations, the control interface 110 can transmit a first signal to the one or more processors when the first input element is activated, causing the one or more processors to transition the lamp assembly 102 between a powered-on state and a powered-off state. The control interface 110 may transmit a second signal to the one or more processors when the second input element is activated, causing the one or more processors to cycle through available languages in a predetermined sequence. The control interface 110 may be electrically coupled to the one or more processors through conductors routed within the reading surface or the stem assembly, such that activation of input elements generates electrical signals transmitted to processing circuitry for interpretation and execution of corresponding control operations.

The stem assembly 106 can include a coupling 112. The coupling 112 can be a mechanical connection element that joins the lamp head 104 to an upper portion of the stem assembly 106. That is, the coupling 112 can provide a mechanical interface between the lamp head 104 and the first link 116 of the stem assembly 106 such that the lamp head 104 is secured to the stem assembly 106 during operation. For example, the coupling 112 can include a cylindrical socket, a threaded connection, a friction fit connection, or an interlocking mechanical interface that secures the lamp head 104 to the first link 116 of the stem assembly 106. The coupling 112 can transmit mechanical forces between the lamp head 104 and the stem assembly 106 to maintain a desired angular position and/or rotational position of the lamp head 104 relative to the stem assembly 106. In some implementations, the coupling 112 can allow the lamp head 104 to be removed and/or detached from the stem assembly 106 for storage, transport, and/or maintenance purposes. The coupling 112 may include electrical contacts and/or connectors that transmit power signals and/or data signals between components in the lamp head 104 and components in the stem assembly 106 and/or the reading surface 108. The coupling 112 may be constructed from materials that provide mechanical strength and durability while being compatible with child-safe design requirements, such as non-toxic plastics, metals with rounded edges, and/or impact-resistant composites.

The stem assembly 106 can include a joint 114. The joint 114 can be an articulation element that permits relative angular movement between the lamp head 104 and the first link 116 of the stem assembly 106. That is, the joint 114 can provide a rotational coupling that allows the lamp head 104 to be repositioned relative to the first link 116 through angular displacement. For example, the joint 114 can include a hinge mechanism, a ball-and-socket connection, or a multi-axis pivot that allows the lamp head 104 to rotate about one or more axes relative to the first link 116. The joint 114 can allow the lamp assembly 102 to transition between different configurations by permitting rotation or angular displacement of components coupled by the joint 114. In some implementations, the joint 114 can include a friction mechanism that maintains a selected angular position of the lamp head 104 during operation while allowing repositioning when users apply force to the lamp head 104. In some implementations, the joint 114 can include a locking mechanism that prevents movement of the lamp head 104 relative to the first link 116 until the locking mechanism is released by user actuation. The joint 114 may include internal bearings that facilitate smooth articulation while minimizing wear over repeated adjustment cycles. The joint 114 may include bushings that reduce friction between moving surfaces of the joint 114 during repositioning operations. The joint 114 may be designed to limit the range of angular motion to prevent the lamp head 104 from rotating into positions that would interfere with operation of the optical elements 126. The joint 114 may prevent the lamp head 104 from rotating beyond a predetermined angular range that would cause instability of the lamp assembly 102 or mechanical interference between the lamp head 104 and the reading surface 108.

The stem assembly 106 can include a first link 116. The first link 116 can be a rigid or semi-rigid structural member that forms an upper portion of the stem assembly 106 between the joint 114 and the joint 118. That is, the first link 116 can extend from the joint 114 adjacent to the lamp head 104 downward to the joint 118 that couples the first link 116 to the second link 120, providing vertical or angled support to maintain spatial separation between the lamp head 104 and the reading surface 108. For example, the first link 116 can include an elongated rod, a tube, or a beam constructed from aluminum alloys, reinforced polymers, or composite materials that provide structural strength while reducing overall weight of the lamp assembly 102. The first link 116 can maintain a selected spatial configuration during operation by resisting deflection under the weight of the lamp head 104 and forces applied during user adjustment of the lamp assembly 102. In some implementations, the first link 116 can include internal channels or conduits that route electrical conductors between components in the lamp head 104 and components in the reading surface 108 or lower portions of the stem assembly 106. The internal channels can protect electrical conductors from mechanical damage and can provide routing pathways that avoid interference with articulation of the joints 114, 118 during folding or repositioning operations. In some implementations, the first link 116 can include surface treatments, coatings, or finishes that provide resistance to wear, scratches, or environmental exposure. The surface treatments can be applied to external surfaces of the first link 116 to enhance aesthetic appearance and durability during repeated adjustment cycles and extended use periods.

The stem assembly 106 can include a joint 118. The joint 118 can be an articulation element that permits relative angular movement between the first link 116 and the second link 120 of the stem assembly 106. That is, the joint 118 can provide a rotational coupling that allows the first link 116 and the second link 120 to rotate relative to one another through angular displacement. For example, the joint 118 can include a hinge mechanism, a ball-and-socket connection, or a multi-axis pivot that allows the first link 116 and the second link 120 to rotate relative to each other. The joint 118 can allow the stem assembly 106 to fold or collapse by permitting the first link 116 and the second link 120 to move toward each other as the lamp assembly 102 transitions from an extended configuration to a folded configuration. In some implementations, the joint 118 can include a friction mechanism that maintains a selected angular relationship between the first link 116 and the second link 120 during operation while allowing repositioning when users apply force to the first link 116 and/or the second link 120. In some implementations, the joint 118 can include a locking mechanism that prevents movement of the first link 116 relative to the second link 120 until the locking mechanism is released by user actuation. The joint 118 may include internal bearings that facilitate smooth articulation while minimizing wear over repeated adjustment cycles. The joint 118 may include bushings that reduce friction between moving surfaces of the joint 118 during repositioning operations. The joint 118 may be designed to provide a predetermined range of angular motion that allows the stem assembly 106 to transition between the extended configuration and the folded configuration while preventing over-rotation that could damage components or electrical conductors. The joint 118 may prevent the first link 116 from rotating beyond a predetermined angular range relative to the second link 120 that would cause instability of the lamp assembly 102 or mechanical interference between the first link 116 and the second link 120.

The stem assembly 106 can include a second link 120. The second link 120 can be a rigid or semi-rigid structural member that forms a lower portion of the stem assembly 106 between the joint 118 and the joint 122. For example, the second link 120 can include an elongated rod, a tube, or a beam that extends from the joint 118 to the joint 122 near the reading surface 108. The second link 120 can couple the first link 116 to the reading surface 108 through the joints 118 and 122, thereby completing a mechanical path between the lamp head 104 and the reading surface 108. In some implementations, the second link 120 can include internal channels or conduits that route electrical conductors between the first link 116 and components housed in or near the reading surface 108. The second link 120 may be constructed from lightweight materials such as aluminum alloys, reinforced polymers, or composite materials that provide structural strength while minimizing overall weight of the lamp assembly 102. The second link 120 may have a length and geometry that, in combination with the first link 116, positions the lamp head 104 at an appropriate working height above the reading surface 108 when the stem assembly 106 is in the extended configuration.

The stem assembly 106 can include a joint 122. The joint 122 can be an articulation element that permits relative angular movement between the second link 120 and the reading surface 108. That is, the joint 122 can provide a rotational coupling that allows the second link 120 to rotate relative to the reading surface 108 through angular displacement. For example, the joint 122 can include a hinge mechanism, a ball-and-socket connection, or a multi-axis pivot that allows the second link 120 to rotate about one or more axes relative to the reading surface 108. The joint 122 can allow the stem assembly 106 to transition between different configurations by permitting rotation or angular displacement of the second link 120 coupled by the joint 122. In some implementations, the joint 122 can allow the lamp assembly 102 to transition from an extended configuration to a folded configuration by allowing the second link 120 to fold toward the reading surface 108. In some implementations, the joint 122 can include a friction mechanism that maintains a selected angular position of the second link 120 relative to the reading surface 108 during operation while allowing repositioning when users apply force to the second link 120. In some implementations, the joint 122 can include a locking mechanism that prevents movement of the second link 120 relative to the reading surface 108 until the locking mechanism is released by user actuation. The joint 122 may include internal bearings that facilitate smooth articulation while minimizing wear over repeated adjustment cycles. The joint 122 may include bushings that reduce friction between moving surfaces of the joint 122 during repositioning operations. The joint 122 may be designed to limit the range of angular motion to prevent the second link 120 from rotating into positions that would cause mechanical interference with the reading surface 108 and/or damage to electrical conductors passing through the joint 122. The joint 122 may prevent the second link 120 from rotating beyond a predetermined angular range that would cause instability of the lamp assembly 102 and/or mechanical interference between the second link 120 and the reading surface 108.

The stem assembly 106 can include a coupling 124. The coupling 124 can be a mechanical connection element that joins the second link 120 to the reading surface 108 through or adjacent to the joint 122. That is, the coupling 124 can provide a mechanical interface between the second link 120 and the reading surface 108 such that the second link 120 is secured to the reading surface 108 during operation. For example, the coupling 124 can include a cylindrical socket, a threaded connection, a friction fit connection, or an interlocking mechanical interface that secures the second link 120 to the reading surface 108. The coupling 124 can transmit mechanical forces between the second link 120 and the reading surface 108 to maintain stability of the lamp assembly 102 during operation. In some implementations, the coupling 124 can allow the stem assembly 106 to be removed or detached from the reading surface 108 for storage, transport, or maintenance purposes. The coupling 124 may include electrical contacts or connectors that transmit power signals and/or data signals between components in the stem assembly 106 and components housed in or on the reading surface 108. The coupling 124 may be constructed from materials that provide mechanical strength and durability while being compatible with child-safe design requirements, such as non-toxic plastics, metals with rounded edges, or impact-resistant composites that prevent injury during handling or accidental impacts.

The lamp head 104 can include optical elements 126. The optical elements 126 can be components housed within or on the lamp head 104 that perform image capture and projection functions for augmented reality operations. That is, the optical elements 126 can include imaging sensors, projection optics, and illumination sources that operate together to capture visual data from book pages and display augmented reality content onto those pages. For example, the optical elements 126 can include a camera configured to capture images of pages of books, a projector configured to project augmented reality content onto the pages, and light sources configured to illuminate the pages. The optical elements 126 can capture images of a page of a book and project augmented reality projections of translated text or visual content in visual proximity to the page of the book. In some implementations, the optical elements 126 can include a camera that uses optical character recognition to scan printed text in a book placed under the lamp assembly and converts scanned images into text in real time. The optical elements 126 may include a compact, low-power projector embedded in the lamp head 104 that projects augmented reality visuals such as translations, icons, and animations onto book pages or nearby surfaces. The optical elements 126 may include camera sensors, projection lenses, focusing mechanisms, and illumination sources that work in combination with one or more processors to align projected augmented reality content with the physical layout of book pages.

In some implementations, the optical elements 126 can include focusing mechanisms that adjust focal distance of the camera or the projector based on detected distance between the lamp head 104 and the reading surface to maintain sharp image capture and projection alignment. The optical elements 126 may include optical filters positioned in front of the camera to reduce glare or reflections from the book pages during image capture operations. The optical elements 126 may include projection lenses with keystone correction optics to compensate for angular misalignment between the projector and the book page, such that projected augmented reality content appears undistorted when viewed from typical reading positions.

The reading surface 108 can include a coupling 128. The coupling 128 can be a mechanical connection element that joins components of the control interface 110 to the reading surface 108. For example, the coupling 128 can include a mounting bracket, a threaded connection, an adhesive bond, or a snap-fit interface that secures the control interface 110 to the reading surface 108. The coupling 128 can position the control interface 110 at an accessible location on the reading surface 108 where users can interact with input elements of the control interface 110. In some implementations, the coupling 128 can provide a secure mechanical connection while allowing the control interface 110 to be accessed or serviced without disassembling the entire lamp assembly 102. The coupling 128 may be designed to maintain alignment and stability of the control interface 110 during repeated user interactions with input elements such as buttons or switches. In some implementations, the coupling 128 can include fasteners or retention features that prevent displacement of the control interface 110 when users apply force to activate buttons or switches during operation of the lamp assembly 102.

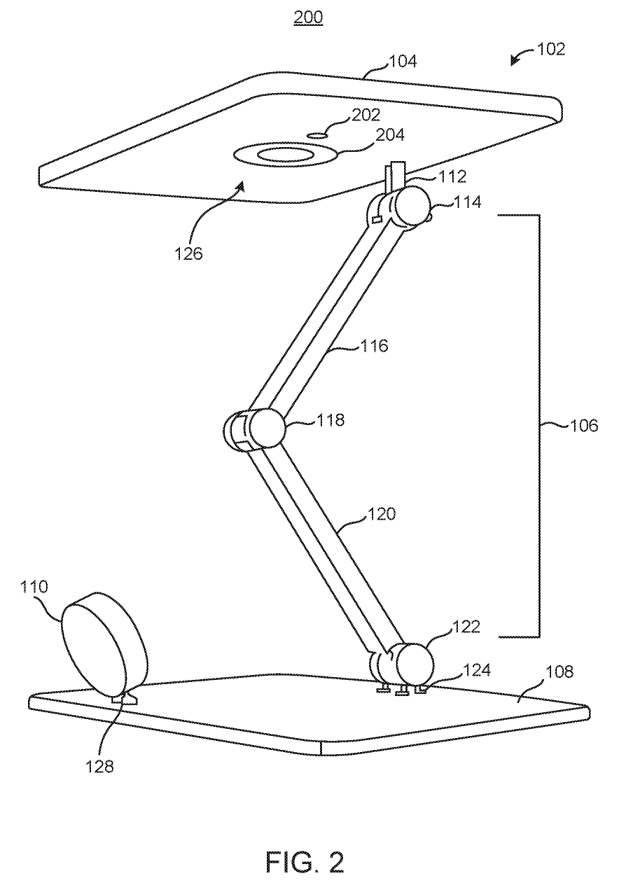

Referring now to FIG. 2, illustrated is a perspective view 200 of the bilingual augmented reality lamp assembly 102 moving from an extended configuration to a folded configuration. The lamp assembly 102 can include the lamp head 104, the stem assembly 106, the reading surface 108, the control interface 110, the optical elements 126, and the plurality of couplings 112, 124, 128 and joints 114, 118, 122 coupling various components of the lamp assembly 102. The stem assembly 106 can include the first link 116 and the second link 120. The optical elements 126 can include a camera 202 and a projector 204.

FIG. 2 can illustrate the bilingual augmented reality lamp assembly 102 transitioning from an extended configuration to a folded configuration through articulation of the stem assembly 106. That is, the joints 114, 118, 122 of the stem assembly 106 can permit angular displacement of the links 116, 120 relative to one another and relative to the lamp head 104 and the reading surface 108, such that the lamp assembly 102 can be reconfigured between a deployed state for reading operations and a compact state for storage and/or transport. For example, the joint 118 can allow the first link 116 and the second link 120 to rotate toward each other, reducing the overall height of the lamp assembly 102 and positioning the lamp head 104 closer to the reading surface 108. In some implementations, the folded configuration can reduce the volume occupied by the lamp assembly 102 to facilitate placement in a carrying case, a storage compartment, or a backpack for transport between locations. The folded configuration can be achieved by applying manual force to the lamp head 104 and/or the links 116, 120 to rotate the joints 114, 118, 122 beyond their extended positions, causing the stem assembly 106 to collapse into a folded arrangement. In some implementations, the joints 114, 118, 122 can include detent mechanisms, friction elements, or locking features that hold the lamp assembly 102 in the folded configuration without requiring continuous application of force by a user.

The optical elements 126 can include a camera 202. The camera 202 can be an image capture device coupled to the lamp head 104 and configured to capture images of a page of a book placed beneath the lamp assembly 102. For example, the camera 202 can include a digital imaging sensor with associated optics that converts light reflected from a book page into digital image data representing the visual content of the page. The camera 202 can capture images of pages of books to provide input data for optical character recognition processing and content identification operations performed by the lamp assembly 102. In some implementations, the camera 202 can scan printed text in a book or material placed under the lamp assembly 102 and transmit the captured images to one or more processors for text extraction and translation. The camera 202 may obtain images continuously or at predetermined intervals as pages are read, and may adjust exposure settings, focus, or other capture parameters based on lighting conditions or page characteristics. The camera 202 may transmit captured image data to processing components through electrical connections within the lamp head 104, where the image data can be processed using optical character recognition algorithms to extract textual content from the page. In some implementations, the camera 202 can detect a machine-readable code such as a QR code or barcode printed on at least a portion of the book, which the one or more processors can use to determine an identifier of the book and access corresponding translation data from a language dictionary stored in memory. The camera 202 may detect boundaries of the page based on edge detection algorithms applied to the captured images, such that the one or more processors can align augmented reality projections within the detected boundaries of the page. The camera 202 may capture images that include visual content such as illustrations, photographs, or diagrams printed on the page, which the one or more processors can process to generate augmented reality projections that correspond to the visual content depicted in the book.

The optical elements 126 can include a projector 204. The projector 204 can be an optical projection device coupled to the lamp head 104 and configured to project augmented reality content onto surfaces beneath the lamp assembly 102. That is, the projector 204 can emit visible light forming projected images on book pages and/or other surfaces positioned below the lamp head 104. For example, the projector 204 can include a light source, projection optics, image generation circuitry, and focusing elements that produce projected images at a projection distance corresponding to a working distance between the lamp head 104 and the reading surface 108. The projector 204 can project augmented reality projections of translated text and/or visual content in visual proximity to pages of books to provide bilingual learning experiences. In some implementations, the projector 204 can display bilingual content such as text, educational material, symbols, and/or interactive games onto book pages in response to processing operations performed on images captured by the camera 202. The projector 204 can operate as a low-power projection system that works with one or more processors and the camera 202 to align projected text, icons, and animations with the physical layout of book pages. The projector 204 can receive image data and/or projection commands from processing components within the lamp head 104 and/or the reading surface 108. The projector 204 can adjust projection parameters such as focus, brightness, keystone correction, color balance, and/or projection angle to maintain accurate alignment with the book page as the lamp assembly 102 is repositioned. In some implementations, the projector 204 can include a digital micromirror device, a liquid crystal on silicon panel, a laser scanning module, and/or an LED-based projection system that generates images for projection onto the book page. The projector 204 can include focusing optics that adjust a focal plane of the projected image based on a detected distance between the lamp head 104 and the book page captured by the camera 202. The projector 204 can receive projection alignment parameters from the one or more processors that indicate boundaries of the book page, such that the projector 204 adjusts keystone correction and/or geometric transformation parameters to confine projected content within the detected boundaries. The projector 204 can modulate brightness and/or contrast of projected images based on ambient lighting conditions detected by the camera 202 and/or a separate ambient light sensor coupled to the lamp head 104.

In some implementations, the projector 204 and the optical elements 126 are configured to generate a three-dimensional holographic image that appears to be suspended above the reading surface 108. In such implementations, the optical elements 126 can include a holographic display module that produces a volumetric light field representing a holographic reconstruction of the augmented reality content. For example, the holographic display module can comprise a spatial light modulator (“SLM”) such as a liquid crystal on silicon (LCOS) panel, a digital micromirror device (DMD), or a phase-only liquid crystal panel that modulates a coherent or partially coherent light beam from a light source to encode holographic interference patterns. The SLM can be driven by hologram computation circuitry executed by the one or more processors, which generate holographic fringe patterns corresponding to a desired three-dimensional distribution of light. A collimating lens and one or more projection lenses can direct the modulated light into free space beneath the lamp head 104 such that a user perceives a three-dimensional holographic representation of text, icons, or visual objects located in a volume above the book page.

In some implementations, the holographic display module can be implemented as a swept-volume holographic projector. For example, the optical elements 126 can include a stack of two or more semi-transparent display planes, each comprising an SLM or other light modulation surface, arranged at different depths relative to the lamp head 104. The projector 204 can rapidly update holographic patterns on each display plane while the one or more processors drive the light source and modulation patterns in a time-multiplexed manner. By projecting different slices of a three-dimensional scene onto different planes at sufficiently high refresh rates, the system can generate a volumetric image that appears to occupy a continuous volume above the reading surface 108. In some implementations, a mechanical actuator can move a single SLM or screen through a range of depths, while the projector 204 updates holographic patterns synchronously with the movement to create a swept-volume effect. The one or more processors can synchronize the hologram computation with the position and orientation of the lamp assembly 102 and with the detected position of the book page, such that the volumetric holographic content remains registered with printed content on the page from a range of viewing angles.

In some implementations, the optical elements 126 can further include a holographic optical element (“HOE”), such as a diffractive lens or holographic combiner plate, positioned between the projector 204 and the reading surface 108. The HOE can be configured to redirect and shape the modulated light from the projector 204 so that a reconstructed holographic image appears at a desired virtual depth above the book page. For example, the HOE can be engineered to focus different portions of the encoded holographic wavefront at different depths, thereby enabling a user to perceive text, icons, or animated characters as floating at various distances above the page. The HOE can be implemented as a volume hologram recorded in a photopolymer or glass substrate and integrated into the lamp head 104. The one or more processors can generate holographic patterns that take into account the phase function of the HOE so that the reconstructed image is properly formed and aligned with the underlying printed content on the book page.

In some implementations, the projector 204 can operate selectively in a two-dimensional projection mode and a three-dimensional holographic mode. In the two-dimensional projection mode, the projector 204 projects conventional images directly onto the book page or reading surface 108, as described above. In the three-dimensional holographic mode, the projector 204 drives the holographic display module and associated optical elements 126 to generate a volumetric holographic reconstruction of augmented reality content above the book page. The one or more processors can select between the two-dimensional projection mode and the three-dimensional holographic mode based on at least one of: a user setting, available processing power, ambient lighting conditions, or a type of content being displayed. In some implementations, the system can present static text overlays using the two-dimensional projection mode and present animated objects, characters, or instructional indicators using the three-dimensional holographic mode to enhance engagement during bilingual reading sessions.

In some implementations, the projector 204 and optical elements 126 are configured to create an apparent three‑dimensional augmented reality image above the book page using an optical combiner. For example, the optical elements 126 can include a partially reflective plate, such as a glass or plastic substrate coated with a semi‑reflective layer, positioned at an angle between the projector 204 and the reading surface 108. The projector 204 can project images onto a projection surface, such as an internal screen or a portion of the reading surface 108, and the partially reflective plate can reflect the projected images toward the user while also transmitting light from the physical book page. As a result, the user perceives the projected images as floating above the book page, even though the underlying projection is two‑dimensional. In some implementations, the partially reflective plate can be fixed within the lamp head 104 or can be configured to be deployed or retracted based on a user‑selected mode.

In some implementations, the optical elements 126 can include additional mirrors, lenses, or prisms arranged to fold the optical path between the projector 204 and the partially reflective plate, allowing the lamp assembly 102 to maintain a compact form factor while producing a virtual image that appears at a comfortable viewing distance above the reading surface 108. The one or more processors can generate image data that is pre‑warped or geometrically transformed to account for the angle and optical characteristics of the partially reflective plate and associated optics, such that the reflected image appears undistorted and spatially registered with the book page. The projector 204 can also adjust focus and brightness of the projected images based on a distance between the user and the optical combiner and based on ambient lighting conditions, thereby maintaining a clear, legible floating image in a variety of viewing environments.

In some implementations, the projector 204 can be configured to project augmented reality content onto a wall or other vertical surface in the vicinity of the lamp assembly 102. For example, the projector 204 can enter a wall‑projection mode in which bilingual content such as interactive lessons, menus, or tutorial instructions are projected onto a nearby wall or other surface (e.g., vertical plate of the lamp assembly). In some embodiments, the one or more processors can determine an available wall region using images captured by the camera 202 and adjust the projection geometry, keystone correction, and focus parameters so that the projected content appears upright and properly scaled on the vertical surface. The user can thus view augmented reality content either on the book page, floating above the book page via an optical combiner, or on a wall, depending on context and user preference. In some implementations, the lamp assembly 102 can also interoperate with external devices, such as wearable displays or handheld devices, to facilitate or enhance the appearance or perception of augmented reality content. For example, the lamp assembly 102 can provide projections via a head‑mounted display, smart glasses, or a handheld device configured to render content representations in visual proximity to the book page. In some embodiments, the projector 204 can continue to project content onto the reading surface 108, into a volumetric holographic region, and/or onto a wall, while the external device supplements or enhances the visual display from the perspective of the user. In other implementations, the lamp assembly 102 can be configured to operate entirely as a stand‑alone system, without any paired external devices, using only the projector 204, camera 202, and optical elements 126 to present augmented reality content to the user.

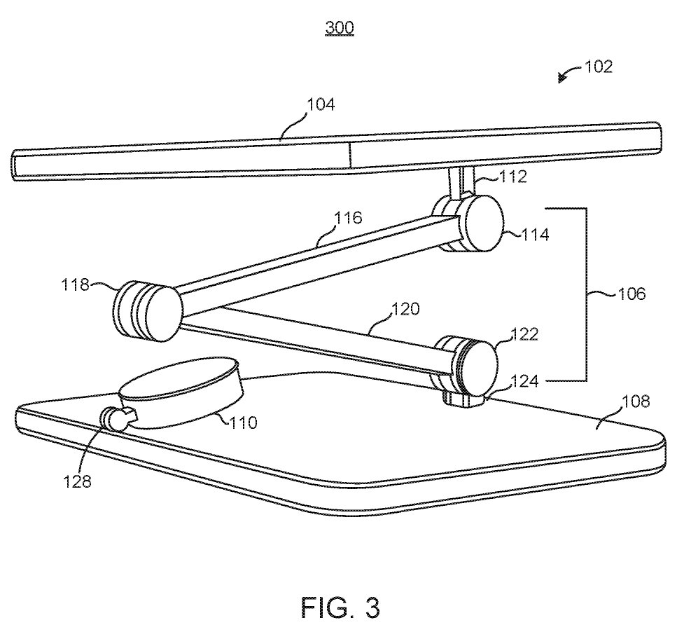

Referring now to FIG. 3, illustrated is a perspective view 300 of the bilingual augmented reality lamp assembly 102 moving from an extended configuration to a folded configuration. The lamp assembly 102 can include the lamp head 104, the stem assembly 106, the reading surface 108, the control interface 110, and the plurality of couplings 112, 124, 128 and joints 114, 118, 122 coupling various components of the lamp assembly 102. The stem assembly 106 can include the first link 116 and the second link 120.

FIG. 3 can illustrate the bilingual augmented reality lamp assembly 102 continuing to move from the extended configuration toward the folded configuration through further articulation of the stem assembly 106. That is, the joints 114, 118, 122 can permit additional angular displacement of the links 116, 120 relative to one another and relative to the lamp head 104 and the reading surface 108 beyond the positions shown in FIG. 2, such that the lamp assembly 102 can be transitioned into a more compact folded state. For example, the joint 118 can allow the first link 116 and the second link 120 to rotate further toward each other beyond the intermediate position shown in FIG. 2, such that the first link 116 and the second link 120 approach a parallel or collapsed arrangement that reduces the overall height of the lamp assembly 102. The folded configuration can position the lamp head 104 in closer proximity to the reading surface 108, such that the lamp assembly 102 occupies a reduced volume for storage and/or transport. In some implementations, the folded configuration can be achieved by continuing to apply manual force to the lamp head 104 and/or the links 116, 120 to rotate the joints 114, 118, 122 through their full range of motion until the lamp assembly 102 reaches a mechanically stable folded state. In some implementations, the joints 114, 118, 122 can include detent mechanisms, friction elements, and/or locking features that hold the lamp assembly 102 in the folded configuration without requiring continuous application of force by a user, such that the lamp assembly 102 remains in the folded configuration during transport and/or storage operations. The folded configuration can reduce the overall height of the lamp assembly 102 by bringing the lamp head 104 closer to the reading surface 108, such that the lamp assembly 102 can be placed in a carrying case, a storage compartment, and/or a backpack without the lamp head 104 extending significantly above the reading surface 108. In some implementations, the control interface 110 can remain accessible on the reading surface 108 in the folded configuration, allowing users to power off the lamp assembly 102 and/or perform other control operations while the lamp assembly 102 is in the folded configuration.

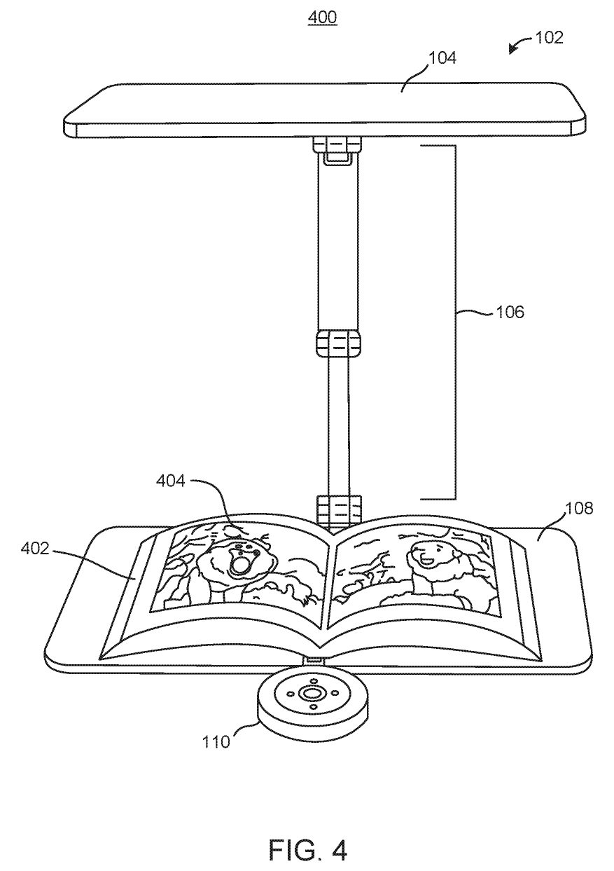

Referring now to FIG. 4, illustrated is a schematic view 400 of the bilingual augmented reality lamp assembly 102 positioned to illuminate and project an augmented reality projection onto an open book 402. The lamp assembly 102 can include the lamp head 104, the stem assembly 106, the reading surface 108, and the control interface 110. The book 402 can include content 404.

The lamp assembly 102 can be positioned to illuminate and project an augmented reality projection onto a book 402. The book 402 can be a physical printed publication that includes text, illustrations, or other visual content on pages. That is, the book 402 can include bound or assembled pages with printed material that conveys information through written language and/or pictorial representations. For example, the book 402 can include a children’s storybook, an educational textbook, a language learning book, a reference book, a workbook, or any other printed publication that contains content for reading and learning. The book 402 can be placed on the reading surface 108 beneath the lamp head 104 to receive illumination and augmented reality projections during reading operations. In some implementations, the book 402 can include pages with printed text in a first language and illustrations that depict characters, objects, or scenes described in the text. In some implementations, the book 402 may include a machine-readable code such as a QR code or barcode that can be scanned by the camera 202 to identify the specific book 402 and access corresponding translation data or visual assets from a language dictionary stored in the lamp assembly 102. The book 402 may be positioned in an open configuration with two facing pages visible, allowing the camera 202 to capture images of both pages simultaneously and the projector 204 to display augmented reality content across the spread of the open book 402. In some implementations, the book 402 can include pages of varying sizes, thicknesses, or paper finishes, and the camera 202 and the projector 204 can operate across such variations by adjusting focus, exposure, or projection parameters.

The book 402 can include content 404. The content 404 can be textual content, visual content, or a combination of both printed on pages of the book 402. For example, the content 404 can include words, sentences, paragraphs, illustrations, photographs, diagrams, or other visual elements that convey information or tell a story. The content 404 can be captured by the camera 202 in the lamp head 104 and processed by one or more processors to identify textual content in a first language or visual content. In some implementations, the content 404 can include printed text in a first language that is processed using optical character recognition to extract textual information, which is then translated into another language (e.g., a second language, third language, etc.) using one or more language models stored locally on the lamp assembly 102. The one or more processors can process the content 404 line-by-line, where the one or more processors provide audio signals corresponding to the textual content of each line and project augmented reality projections associated with each line in synchronization with the audio narration. The content 404 may include visual elements such as illustrations of animals, people, or objects performing actions, which can be detected by the one or more processors and used to generate augmented reality projections that include motion corresponding to the actions depicted in the content 404.

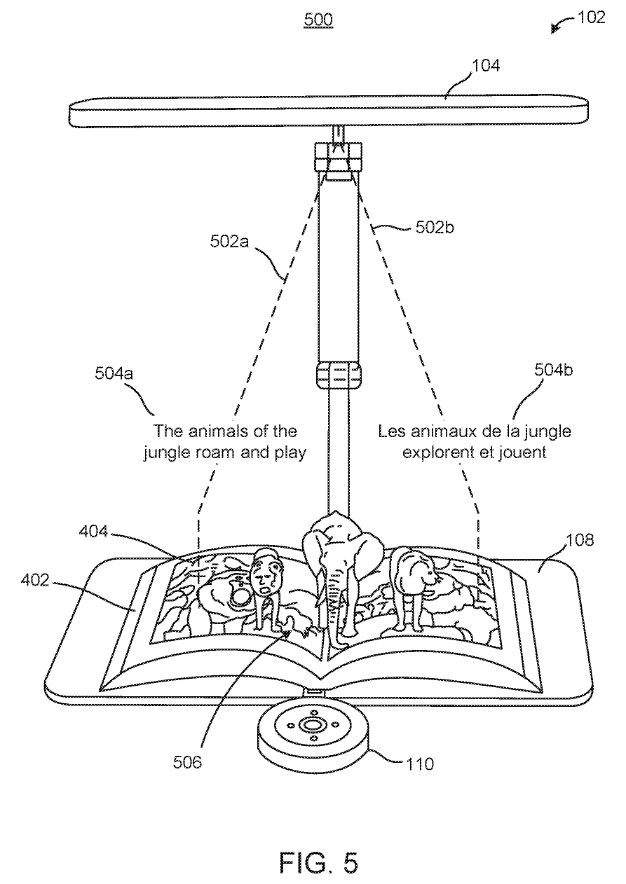

Referring now to FIG. 5, illustrated is a schematic view 500 of the bilingual augmented reality lamp assembly 102 projecting multilingual text and animated visuals onto an open book page. The lamp assembly 102 can include the lamp head 104, the reading surface 108, and the control interface 110. The book 402 can include content 404. The view 500 can include a first projection boundary 502a, a second projection boundary 502b, first language projected text 504a, second language projected text 504b, and an augmented reality projection 506.

The view 500 can include a first projection boundary 502a. The first projection boundary 502a can be a spatial extent defining a region within which augmented reality content is projected onto a first page of the book 402. That is, the first projection boundary 502acan delineate a geometric area on the first page where the projector 204 displays translated text, visual elements, and/or animated content. For example, the first projection boundary 502a can include a rectangular outline, a polygonal outline, and/or a contour outline that corresponds to detected edges of a left-hand page of the book 402 as captured by the camera 202. The first projection boundary 502a can define the area within which the projector 204 displays augmented reality projections such as translated text and/or visual content associated with the content 404 on the first page. In some implementations, the first projection boundary 502a can be determined by one or more processors that detect boundaries of the page based on images captured by the camera 202 and align the augmented reality projection within the boundaries of the page. The one or more processors can execute image processing algorithms that identify edges, corners, and/or other geometric features of the physical page to establish the first projection boundary 502a. In some implementations, the first projection boundary 502a can be updated dynamically as the book 402 is repositioned and/or as pages are turned, such that projected content remains aligned with the physical page throughout reading operations. The one or more processors can detect changes in page position and/or page orientation from successive images captured by the camera 202, and can adjust geometric transformation parameters for the projector 204 to maintain alignment of the augmented reality projection within the first projection boundary 502a. In some implementations, the first projection boundary 502a can be calculated by detecting a perimeter of the page using edge detection algorithms, corner detection algorithms, and/or contour tracing algorithms applied to the images captured by the camera 202. The one or more processors can apply keystone correction parameters to compensate for angular misalignment between the projector 204 and the first page of the book 402, such that the augmented reality projection appears undistorted when viewed within the first projection boundary 502a.

The view 500 can include a second projection boundary 502b. The second projection boundary 502b can be a spatial extent defining a region within which augmented reality content is projected onto a second page of the book 402. That is, the second projection boundary 502b can delineate a geometric area on the second page where the projector 204 displays translated text, visual elements, and/or animated content. For example, the second projection boundary 502b can include a rectangular outline, a polygonal outline, and/or a contour outline that corresponds to detected edges of a right-hand page of the book 402 as captured by the camera 202. The second projection boundary 502b can define the area within which the projector 204 displays augmented reality projections such as translated text and/or visual content associated with the content 404 on the second page. In some implementations, the second projection boundary 502b can be determined by one or more processors that detect boundaries of the page based on images captured by the camera 202 and align the augmented reality projection within the boundaries of the page. The one or more processors can execute image processing algorithms that identify edges, corners, and/or other geometric features of the physical page to establish the second projection boundary 502b. In some implementations, the second projection boundary 502b can be updated dynamically as the book 402 is repositioned and/or as pages are turned, such that projected content remains aligned with the physical page throughout reading operations. The one or more processors can detect changes in page position and/or page orientation from successive images captured by the camera 202, and can adjust geometric transformation parameters for the projector 204 to maintain alignment of the augmented reality projection within the second projection boundary 502b. In some implementations, the second projection boundary 502b can be calculated by detecting a perimeter of the page using edge detection algorithms, corner detection algorithms, and/or contour tracing algorithms applied to the images captured by the camera 202. The one or more processors can apply keystone correction parameters to compensate for angular misalignment between the projector 204 and the second page of the book 402, such that the augmented reality projection appears undistorted when viewed within the second projection boundary 502b. The second projection boundary 502b can be independently determined from the first projection boundary 502a to accommodate variations in page geometry, positioning, and/or curvature that occur when the book 402 is open across two facing pages.

The view 500 can include first language projected text 504a. The first language projected text 504a can be augmented reality content displaying textual information in a first language projected onto a page of the book 402. That is, the first language projected text 504a can include visible text rendered by the projector 204 within the first projection boundary 502a on the physical surface of the page. For example, the first language projected text 504a can include English text reading “The animals of the jungle roam and play” that is projected within the first projection boundary 502a to provide a translation of the content 404 on the page. The first language projected text 504a can provide an output comprising an augmented reality projection of translated textual content in visual proximity to the page of the book 402. In some implementations, the first language projected text 504a can be generated by one or more processors that process the content 404 using one or more models to determine that the content 404 corresponds to textual content in a second language and then translate the textual content into the first language for projection. The one or more processors can extract textual data from the content 404 using optical character recognition, match recognized words with a language dictionary stored in memory, and generate the first language projected text 504a based on translation data retrieved from the language dictionary. The first language projected text 504a may be displayed in a font, size, and position that aligns with the physical layout of the text in the content 404, such that the projected text appears to overlay the printed text on the page. In some implementations, the first language projected text 504a can be aligned with detected boundaries of text regions in the content 404 by applying geometric transformation parameters calculated from the images captured by the camera 202. The first language projected text 504a may be updated in response to user inputs such as activation of a language selection button on the control interface 110, causing the one or more processors to switch the projected language from the first language to a second language and/or a third language. In some implementations, the one or more processors can replace the first language projected text 504a with second language projected text 504b when the user activates the selection input element 714, such that the augmented reality projection transitions from displaying the translation in the first language to displaying the translation in the second language.

The view 500 can include second language projected text 504b. The second language projected text 504b can be augmented reality content displaying textual information in a second language projected onto a page of the book 402. That is, the second language projected text 504b can include visible text rendered by the projector 204 within the second projection boundary 502b on the physical surface of the page in a language different from the first language projected text 504a. For example, the second language projected text 504b can include French text reading “Les animaux de la jungle explorent et jouent” projected within the second projection boundary 502b to provide a translation of the content 404 on the page. The second language projected text 504b can provide an output comprising an augmented reality projection of the translation of the textual content in the second language in visual proximity to the page of the book 402. In some implementations, the second language projected text 504b can be generated by one or more processors that process the content 404 using one or more models stored locally on the lamp assembly 102 to perform optical character recognition and translation into the second language without requiring external network connectivity. The one or more processors can extract textual data from the content 404 using optical character recognition, match recognized words with a language dictionary stored in memory, and generate the second language projected text 504b based on translation data retrieved from the language dictionary. The second language projected text 504b may be displayed simultaneously with the first language projected text 504a to present bilingual content across two facing pages of the book 402, allowing a user to compare translations in multiple languages during a single reading session. The second language projected text 504b may be displayed in a font, size, and position that aligns with the physical layout of the text in the content 404, such that the projected text appears to overlay the printed text on the page. In some implementations, the second language projected text 504b can be aligned with detected boundaries of text regions in the content 404 by applying geometric transformation parameters calculated from images captured by the camera 202. The second language projected text 504b may be projected in response to an input selecting the second language received via the control interface 110, which causes the one or more processors to provide audio signals of the textual content in the second language while projecting the second language projected text 504b onto the page. In some implementations, the one or more processors can replace the first language projected text 504a with the second language projected text 504b when a user activates the selection input element 714, such that the augmented reality projection transitions from displaying the translation in the first language to displaying the translation in the second language.

The view 500 can include an augmented reality projection 506. The augmented reality projection 506 can be visual content projected onto the book 402 that depicts objects, characters, or scenes corresponding to entities described in the content 404. That is, the augmented reality projection 506 can be an image or animation generated by the projector 204 and displayed on the physical surface of the page of the book 402 to provide visual representations of entities identified in the textual content 404. For example, the augmented reality projection 506 can include an animated representation of jungle animals such as monkeys, elephants, tigers, giraffes, or other creatures that appear to move or interact on the page in synchronization with narration of the textual content by the lamp assembly 102. The augmented reality projection 506 can provide visual content in visual proximity to the page of the book 402 as part of the output generated by the one or more processors based on processing the content 404 using one or more models. In some implementations, the augmented reality projection 506 can be generated by the one or more processors detecting from the content 404 at least one entity selected from animals, people, or objects, wherein the content 404 indicates the at least one entity performing an action, and generating the augmented reality projection 506 using the images captured from the page, a pre-stored visual asset, or an AI-generated visual asset. The one or more processors can detect entities by executing image recognition algorithms or natural language processing algorithms on the content 404 to identify nouns, actions, or descriptive phrases corresponding to animals, people, or objects. The augmented reality projection 506 may include motion corresponding to the action performed by the at least one entity, such that if the content 404 describes an elephant in motion, the projected elephant representation in the augmented reality projection 506 exhibits corresponding movement such as walking, swinging a trunk, or interacting with other projected animals. The motion can be generated by the one or more processors selecting a pre-stored animation sequence from a database (e.g., by matching a preconfigured projection for an type entity that matches a type of an entity included in the content 404), generating a new animation sequence using AI-based motion synthesis, or combining captured images from the book 402 with animated transformations to produce the appearance of movement. The augmented reality projection 506 may be projected in alignment with illustrations or empty regions of the page within the projection boundaries 502a, 502b, and may change dynamically as the one or more processors process content line-by-line and provide audio signals and visual projections associated with each line of the page. In some implementations, the augmented reality projection 506 can be positioned adjacent to printed illustrations on the page of the book 402 to supplement the existing visual content without obscuring the printed material. The augmented reality projection 506 can be updated in response to user inputs received via the input elements 918, such that the one or more processors modify the animated content when a user pauses narration, requests repetition of a line, or switches languages through activation of the selection input element 714.

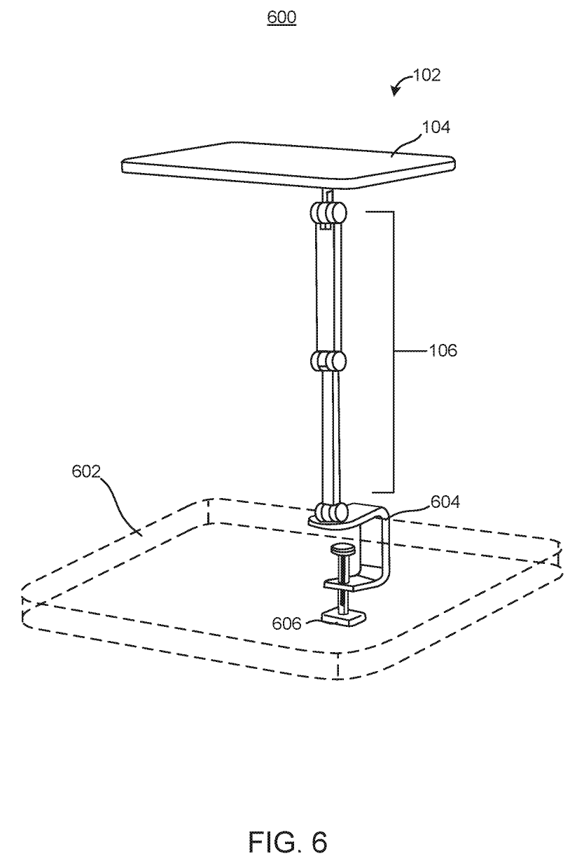

Referring now to FIG. 6, illustrated is a perspective view 602 of the bilingual augmented reality lamp assembly 102 in which the reading surface is separate therefrom and attached using a mounting system 600. The lamp assembly 102 can include the lamp head 104 and the stem assembly 106. The mounting system 600 can include an attachment mechanism 604 and an adjustment element 606.

The lamp assembly 102 can be attached to a separate reading surface using a mounting system 600. The mounting system 600 can be a mechanical assembly that secures the lamp assembly 102 to a reading surface that is separate from the lamp assembly 102. That is, the mounting system 600 can provide a removable attachment interface between the stem assembly 106 and an external support surface that is not integrated as part of the lamp assembly 102. For example, the mounting system 600 can include a clamp, a clip, a friction grip, and/or a clamping mechanism (e.g., mechanical clip) that engages an edge, a corner, and/or a surface of a desk, a table, a shelf, and/or a furniture element to secure the lamp assembly 102 in a fixed position relative to the reading surface. The mounting system 600 can secure the stem assembly 106 and the lamp head 104 to the reading surface to provide stable positioning of the lamp head 104 above books and/or materials placed on the reading surface during operation. In some implementations, the mounting system 600 can allow the lamp assembly 102 to be removably attached to different reading surfaces, providing portability and flexibility in positioning the lamp assembly 102 in various locations and/or environments. The mounting system 600 can transmit mechanical forces from the weight of the lamp head 104 and the stem assembly 106 to the reading surface through clamping engagement and/or gripping engagement, preventing the lamp assembly 102 from tipping and/or shifting during use. In some implementations, the mounting system 600 can be constructed from materials that provide sufficient clamping force to maintain secure attachment while avoiding damage to the surface to which the mounting system 600 is attached, for example, through the use of protective padding, elastomeric contact surfaces, and/or non-marring contact surfaces that distribute clamping forces across contact regions without scratching and/or denting the reading surface.

The mounting system 600 can include an attachment mechanism 604. The attachment mechanism 604 can be a mechanical clamp or clip structure that physically engages a reading surface to secure the lamp assembly 102 in position. That is, the attachment mechanism 604 can provide a mechanical interface between the stem assembly 106 and a separate reading surface through compressive engagement that resists displacement or rotation of the lamp assembly 102. For example, the attachment mechanism 604 can include a C-shaped clamp body with opposing jaws that grip the top and bottom surfaces of a table edge, desk edge, or shelf edge to create a secure mechanical connection. The attachment mechanism 604 can provide the primary mechanical connection between the stem assembly 106 and the separate reading surface by applying compressive forces that resist movement of the lamp assembly 102 during operation. In some implementations, the attachment mechanism 604 can receive the lower end of the stem assembly 106 and couple the stem assembly 106 to the reading surface through a clamping engagement that can be tightened or loosened by the adjustment element 606. The attachment mechanism 604 may include contact surfaces or pads that distribute clamping forces across the reading surface to prevent damage, scratching, or marring of the surface material during installation and use. The contact surfaces can be constructed from elastomeric materials, rubberized coatings, or foam padding that deform under compressive load to increase contact area and reduce stress concentration at engagement points with the reading surface. In some implementations, the attachment mechanism 604 may be designed to accommodate reading surfaces of various thicknesses by providing an adjustable gap between the opposing jaws or contact surfaces, allowing the lamp assembly 102 to be attached to desks, tables, or shelves with different dimensions. The adjustable gap can be controlled by the adjustment element 606 to increase or decrease the separation distance between the opposing jaws, such that the attachment mechanism 604 can grip reading surfaces with thicknesses ranging from thin desk edges to thick tabletops without requiring separate attachment hardware for different surface thicknesses. The attachment mechanism 604 may include guide features or alignment surfaces that position the stem assembly 106 in a desired orientation relative to the reading surface when the attachment mechanism 604 is tightened, such that the lamp head 104 is oriented to direct the camera 202 and the projector 204 toward the reading surface. In some implementations, the attachment mechanism 604 can be removably coupled to the stem assembly 106 through a threaded connection, a snap-fit connection, or a bayonet connection, allowing the attachment mechanism 604 to be replaced or interchanged with attachment mechanisms designed for different mounting applications.

The mounting system 600 can include an adjustment element 606. The adjustment element 606 can be a mechanical actuator that controls clamping force applied by the attachment mechanism 604 to a reading surface. That is, the adjustment element 606 can translate user-applied input motion into compressive force that secures the attachment mechanism 604 to an edge and/or a surface of a table, a desk, and/or a shelf. For example, the adjustment element 606 can include a threaded screw, a lever mechanism, a cam mechanism, and/or a tightening knob that converts rotational motion and/or linear displacement into clamping force between opposing jaws and/or contact surfaces of the attachment mechanism 604. The adjustment element 606 can allow a user to increase clamping force to secure the lamp assembly 102 in a fixed position relative to the reading surface and/or to decrease clamping force to remove and/or reposition the lamp assembly 102. In some implementations, the adjustment element 606 can be rotated and/or actuated to increase and/or decrease separation distance between opposing contact surfaces of the attachment mechanism 604, thereby controlling grip strength on the reading surface. The adjustment element 606 may be positioned at a location accessible to users while the lamp assembly 102 is attached to the reading surface, allowing adjustment of clamping force without requiring disassembly of the mounting system 600. The adjustment element 606 may include a threaded shaft that engages with internal threads in the attachment mechanism 604, such that rotation of the adjustment element 606 causes linear translation of a movable jaw and/or a pressure plate to increase and/or decrease compressive force applied to the reading surface. The adjustment element 606 may include a handle, a knob, and/or a textured gripping surface that facilitates manual rotation by users, such that clamping force can be adjusted without requiring tools and/or external actuators. In some implementations, the adjustment element 606 can include a quick-release mechanism that allows rapid loosening of the attachment mechanism 604 by actuating a lever and/or pressing a release button, such that the lamp assembly 102 can be detached from the reading surface without requiring multiple rotations of a threaded adjustment element.

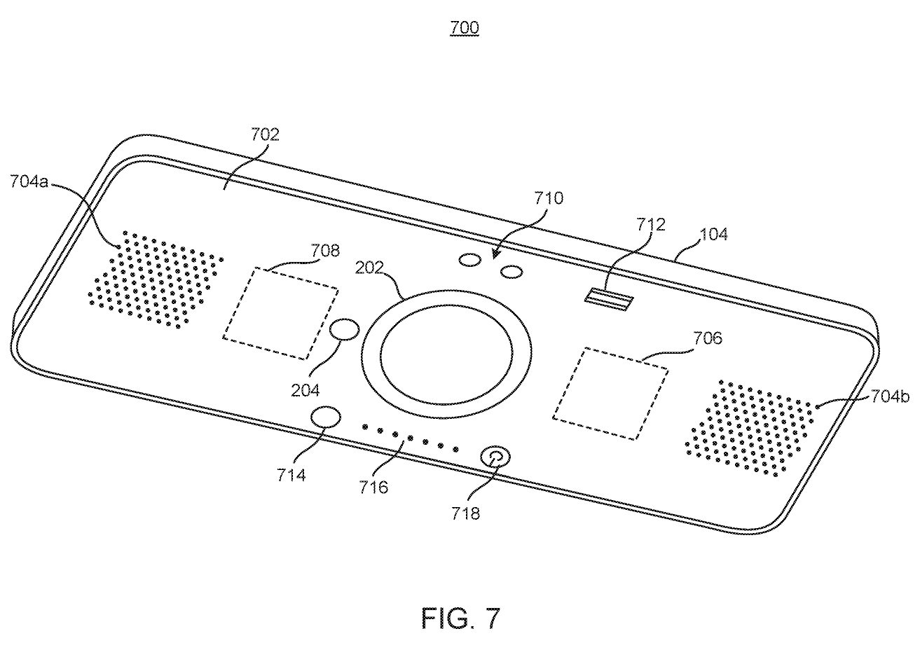

Referring now to FIG. 7, illustrated is a bottom perspective view 700 of the bilingual augmented reality lamp assembly 102 including a control interface, optical elements, auditory elements, and computing devices. The lamp assembly 102 can include the lamp head 104. The lamp head 104 can include the camera 202, the projector 204, a bottom panel 702, a speaker 704a, a speaker 704b, a battery 706, a computing device 708, one or more attachment points 710, a charging port 712, a selection input element 714, a microphone 716, and a power input element 718.

While illustrated in FIG. 7 as included on the bottom panel 702 of the lamp head 104, it should be understood that various components or elements of the lamp assembly 102 can be located on other portions of the lamp assembly 102. That is, the speakers 704a, 704b, the battery 706, the computing device 708, the charging port 712, the selection input element 714, the microphone 716, and/or the power input element 718 can be positioned at alternative locations within the lamp assembly 102 based on design considerations such as accessibility, thermal management, and/or spatial constraints. For example, the speakers 704a, 704b can be located on an upper panel of the lamp head 104 to direct audio output toward users positioned above the lamp assembly 102, or can be located on lateral surfaces of the lamp head 104 to distribute sound across a wider listening area. In some implementations, the selection input element 714 and the power input element 718 can be located on the control interface 110 positioned on the reading surface 108 to provide user access to input controls without requiring interaction with the lamp head 104. The battery 706 can be located within the reading surface 108 to lower the center of gravity of the lamp assembly 102 and improve stability during operation. The charging port 712 can be located on a lateral surface of the lamp head 104, on a surface of the reading surface 108, or on a surface of the stem assembly 106 to provide convenient access for connection of charging cables. The microphone 716 can be located on the bottom panel 702 to capture audio from users positioned near the reading surface 108, or can be located on a lateral surface of the lamp head 104 to reduce acoustic interference from the speakers 704a, 704b. The computing device 708 can be distributed across multiple locations within the lamp assembly 102, such that processing components are housed in the lamp head 104 while memory components are housed in the reading surface 108, or otherwise.

The lamp head 104 can include a bottom panel 702. The bottom panel 702 can be a structural element forming a lower surface of the lamp head 104 and providing mounting locations for optical components, audio components, and processing components. That is, the bottom panel 702 can define a planar or contoured substrate with apertures, mounting bosses, attachment features, and/or openings configured to secure the camera 202, the projector 204, the speakers 704a, 704b, the computing device 708, and/or input elements to the lamp head 104. For example, the bottom panel 702 can include a rigid plate, a molded housing panel, and/or a composite substrate fabricated from materials such as non-toxic plastics, aluminum alloys, and/or reinforced polymers. The bottom panel 702 can position the camera 202 and the projector 204 to face downward toward the reading surface 108 such that the camera 202 captures images of book pages and the projector 204 projects augmented reality content onto those pages. In some implementations, the bottom panel 702 can incorporate acoustic openings aligned with the speakers 704a, 704b to allow audio output to propagate toward users and books positioned beneath the lamp head 104. The acoustic openings can include grilles, perforations, and/or apertures distributed across regions of the bottom panel 702 corresponding to locations of the speakers 704a, 704b. The bottom panel 702 may include optical apertures for the camera 202 lens and the projector 204 optics to prevent obstruction of optical pathways while providing mechanical protection for those components. The optical apertures can include transparent windows fabricated from optical-grade materials such as glass, acrylic, and/or polycarbonate that transmit visible light with reduced attenuation. The bottom panel 702 may be constructed from materials that provide structural rigidity, thermal dissipation for heat-generating components such as the projector 204 and the computing device 708, and compatibility with child-safe design requirements. That is, the bottom panel 702 can avoid sharp edges, detachable small parts, and/or materials that do not meet safety standards for children. In some implementations, the bottom panel 702 can include heat-conductive pathways such as metal inserts, heat sinks, and/or thermal vias that transfer heat from the projector 204 and the computing device 708 to external surfaces for convective cooling.

The lamp head 104 can include speakers 704a-704b. At least one (e.g., each) of the speakers 704a-704b can be an electro-acoustic transducer coupled to the bottom panel 702 and configured to convert electrical audio signals into audible sound waves. That is, the speakers 704a-704b can receive electrical signals representing audio content from the computing device 708 and produce corresponding acoustic output propagating into the surrounding environment. For example, the speakers 704a-704b can include a dynamic loudspeaker driver with a diaphragm, a voice coil, and a magnet assembly that produces sound output in response to audio signals provided by the computing device 708 and/or associated audio processing circuitry. The speakers 704a-704b can provide audio signals comprising a translation of textual content in a selected language as part of the output generated by the one or more processors of the lamp assembly 102. In some implementations, the speakers 704a-704b can output audio narration of book content in a first language and/or a second language based on user selection received via the selection input element 714, with the audio synchronized to visual augmented reality projections displayed by the projector 204. The speakers 704a-704b may provide audio feedback indicating the currently selected language by outputting an audio signal that announces the language name when a user activates the selection input element 714 to switch languages. In some implementations, the speakers 704a-704b may operate in combination to produce stereo audio output and/or increased sound pressure levels, allowing the lamp assembly 102 to deliver pronunciation support and language learning feedback audible to users positioned near the reading surface 108. The speakers 704a-704b may be mounted to the bottom panel 702 under apertures and/or grilles in the bottom panel 702 for sound transmission. The speakers 704a-704b may be electrically coupled to the computing device 708 through conductors routed within the lamp head 104, such that audio signals generated by the computing device 708 are transmitted to the speakers 704a-704b for conversion into audible narration, language feedback, and/or pronunciation outputs.

The lamp head 104 can include a battery 706. The battery 706 can be an electrochemical energy storage device configured to supply electrical power to components of the lamp assembly 102. That is, the battery 706 can store electrical energy and deliver direct current to electronic components within the lamp assembly 102 during operation. For example, the battery 706 can include one or more rechargeable lithium-ion cells, lithium-polymer cells, nickel-metal hydride cells, or other electrochemical cell technologies that store electrical energy through reversible chemical reactions and provide direct current output to power the camera 202, the projector 204, the computing device 708, the speakers 704a, 704b, and other electronic components housed in the lamp head 104. The battery 706 can supply power to at least the camera 202, the at least one output device, and the one or more processors to allow wireless operation of the lamp assembly 102 without requiring connection to external power sources. In some implementations, the battery 706 can receive electrical signals to charge the battery 706 through the charging port 712, which provides a power supply input configured to deliver charging current from an external power adapter, a charging cable, or a charging device. The charging port 712 can transmit charging current to battery management circuitry integrated with the battery 706, which regulates current flow and voltage levels during charging operations. The battery 706 may include integrated battery management circuitry that monitors cell voltages, regulates charging current, and provides protection against overcharge conditions, over-discharge conditions, short-circuit conditions, or thermal runaway conditions. The battery management circuitry can include voltage monitoring circuits that measure potential differences across individual cells or cell groups within the battery 706, current sensing circuits that detect charging current and discharge current, and thermal sensors that measure temperature at one or more locations within the battery 706. The battery management circuitry can disconnect charging current or load current when monitored parameters exceed predetermined thresholds, such that the battery 706 is protected from damage during abnormal operating conditions. The battery 706 may be sized to provide sufficient energy storage capacity to operate the lamp assembly 102 for extended reading sessions, such as multiple hours of continuous operation with the camera 202 capturing images, the projector 204 displaying augmented reality content, and the speakers 704a, 704b providing audio output, without requiring recharging. In some implementations, the battery 706 can provide energy storage capacity sufficient to capture image, process content, and provide outputs continuously for a period of time (e.g., at least two hours, at least five hours of operation, etc.). The battery 706 may be removably coupled to the lamp head 104 through a battery compartment accessible via a cover panel, a retention clip, or a snap-fit connection, allowing the battery 706 to be replaced or removed for maintenance, recycling, or upgrading to a higher-capacity battery without requiring complete disassembly of the lamp head 104.

The lamp head 104 can include a computing device 708. The computing device 708 can be a processing assembly comprising one or more processors coupled with memory and configured to execute instructions for controlling operation of the lamp assembly 102. That is, the computing device 708 can store executable program code in the memory and execute the program code using the one or more processors to perform operations related to image capture, optical character recognition, language translation, augmented reality projection control, and audio output. For example, the computing device 708 can include a microcontroller, a system-on-chip, a processor module with integrated memory, and/or a multi-core processing unit that stores and executes software implementing optical character recognition, language translation, augmented reality projection control, and audio output functions. The computing device 708 can identify, based on images captured by the camera 202, content included on a page of a book, process the content using one or more models, determine that the content corresponds to textual content in a first language and/or visual content, and provide output comprising audio signals and/or augmented reality projections. In some implementations, the computing device 708 can locally process the content included on the page of the book using optical character recognition and a language dictionary stored in memory of the computing device 708 without transmitting data to external servers and/or networks. The computing device 708 can execute optical character recognition algorithms to extract textual data from the images captured by the camera 202, match recognized words with entries in the language dictionary, and generate translations, pronunciations, and visual cues based on the matched dictionary entries. The computing device 708 may store one or more language models, bilingual dictionaries, and AI processing algorithms in non-volatile memory that are accessed during operation to perform text recognition, match recognized words with bilingual dictionaries, generate translations and pronunciations, and adjust augmented reality overlays based on user interaction detected via the microphone 716 and/or input elements 918. The computing device 708 may receive image data from the camera 202, generate control signals for the projector 204 to display aligned augmented reality projections within detected page boundaries, and transmit audio data to the speakers 704a, 704b to provide synchronized narration and language feedback. The computing device 708 can execute projection alignment algorithms that detect boundaries of the page based on the images captured by the camera 202, calculate geometric transformations to align augmented reality projections with the physical page layout, and transmit projection control parameters to the projector 204 to maintain accurate alignment as pages are turned and/or as the lamp assembly 102 is repositioned. In some implementations, the computing device 708 can execute interactive learning algorithms that adjust augmented reality overlays and lighting based on user interaction, provide adaptive feedback such as confirming correct pronunciation, and learn user preferences over time such as frequently used languages and/or difficulty levels. The computing device 708 may execute models (e.g., AI models, language processing models, etc.) to generate translations of textual content from a first language to a second language, generate augmented reality visual content corresponding to entities detected in the textual content, and produce animated augmented reality projections that include motion corresponding to actions described in the textual content.

The lamp head 104 can include one or more attachment points 710. The attachment points 710 can be mechanical mounting features on the bottom panel 702 that provide connection locations for securing components or accessories to the lamp head 104. In some implementations, the attachment points 710 can receive fasteners that couple the stem assembly 106 to the lamp head 104, such that the coupling 112 secures the stem assembly 106 to the lamp head 104 through mechanical engagement of coupling 112 the with the attachment points 710.

The lamp head 104 can include a charging port 712. The charging port 712 can be an electrical connector positioned on the bottom panel 702 and configured to receive charging current from an external power source. That is, the charging port 712 can provide an interface through which electrical energy is transferred from a charging cable and/or a charging pad to the battery 706. For example, the charging port 712 can include a USB-C receptacle, a micro-USB receptacle, a proprietary connector receptacle, and/or a wireless charging coil that couples electrical energy from a charging cable and/or a charging pad to the battery 706. The charging port 712 can provide a power supply input configured to provide electrical signals to charge the battery 706 that supplies power to the camera 202, the projector 204, and the computing device 708. In some implementations, the charging port 712 can receive a charging cable connected to an external power adapter that converts alternating current from a wall outlet to direct current charging voltage delivered through the charging port 712 to battery management circuitry within the lamp head 104. The charging port 712 may be positioned on the bottom panel 702 at a location accessible to users while the lamp assembly 102 is in an extended configuration, allowing the battery 706 to be recharged without requiring the lamp assembly 102 to be folded and/or disconnected from the reading surface 108. The charging port 712 may include data communication capabilities in addition to power delivery, such that firmware updates, language content updates, and/or configuration data can be transferred to the computing device 708 through the charging port 712 while the battery 706 is being recharged. The charging port 712 may include signal conditioning circuits that regulate voltage levels of data signals transmitted through the charging port 712. In some implementations, the charging port 712 can detect when a charging cable is connected and transmit a signal to the computing device 708 indicating that external power is available.

The lamp head 104 can include a selection input element 714. The selection input element 714 can be a user-operable control element configured to receive user inputs for switching between languages for output provided by the lamp assembly 102. That is, the selection input element 714 can detect user activation and transmit corresponding signals to the computing device 708 to change the language used for audio narration and augmented reality projections. For example, the selection input element 714 can include a pushbutton switch that generates an electrical signal when pressed, a momentary contact switch that closes a circuit when activated, and/or a capacitive touch sensor that detects proximity of a user’s finger, among others. The selection input element 714 can receive user inputs for switching between a plurality of languages for the output, the plurality of languages comprising at least a first language, a second language, and a third language. In some implementations, the selection input element 714 can be positioned on the bottom panel 702 separate from the power input element 718, such that users can activate the selection input element 714 to cycle through available languages while the lamp assembly 102 is powered on and operating. The selection input element 714 can transmit a signal to the computing device 708 when activated, causing the one or more processors to switch from providing audio signals of textual content in a first language to providing audio signals of the textual content in a second language. The one or more processors can update projected augmented reality content to display translated text in the newly selected language in response to the signal from the selection input element 714. In some implementations, the selection input element 714 can trigger the speakers 704a, 704b to provide an audio signal indicating the second language is selected for the output. The audio signal can include a spoken announcement of the language name to provide feedback confirming the language switch (e.g., in combination with or in place of visual indicators). The selection input element 714 may cycle through the plurality of languages in a predetermined sequence each time the selection input element 714 is activated, such that repeated activation of the selection input element 714 advances through available languages in order. In some implementations, the selection input element 714 can transmit a signal to the computing device 708 that causes the computing device 708 to retrieve translation data corresponding to the newly selected language from the database 928 and/or the memory 908. The computing device 708 can access the translation data and generate audio signals and augmented reality projections in the selected language based on the retrieved translation data.

The lamp head 104 can include a microphone 716. The microphone 716 can be an acoustic-to-electrical transducer coupled to the bottom panel 702 and configured to capture audio signals from users or the surrounding environment. That is, the microphone 716 can convert sound pressure waves incident on a sensing element into electrical signals representing acoustic input. For example, the microphone 716 can include an electret condenser microphone, a micro-electromechanical systems microphone, or a dynamic microphone that generates electrical signals in response to voice commands, pronunciation attempts, or other audible inputs from users positioned near the reading surface 108. The microphone 716 can receive voice commands from a user to control functions of the lamp assembly 102 such as language selection, playback control, or interaction with projected augmented reality content. In some implementations, the microphone 716 can capture audio of a user reading or speaking words in a selected language, and the computing device 708 can process the captured audio to provide adaptive feedback such as confirming correct pronunciation as part of interactive learning operations. The microphone 716 can transmit captured audio signals to the computing device 708 through electrical conductors routed within the lamp head 104, such that the computing device 708 receives acoustic data for processing by voice recognition algorithms that detect spoken commands, extract pronunciation data for comparison with reference pronunciations, or identify user preferences for adaptive learning behavior. In some implementations, the microphone 716 can be positioned on the bottom panel 702 facing downward toward the reading surface 108 to capture audio from users positioned near the book 402 while minimizing pickup of ambient noise or acoustic reflections from other directions. The microphone 716 may include a directional acoustic pattern that attenuates sound waves arriving from directions other than the reading surface 108, such that voice commands and pronunciation attempts are captured with improved signal-to-noise ratio relative to omnidirectional microphone designs. In some implementations, the microphone 716 can be electrically coupled to the computing device 708 through an analog-to-digital converter that converts the electrical signals from the microphone 716 into digital audio data samples stored in memory for subsequent processing.

The lamp head 104 can include a power input element 718. The power input element 718 can be a user-operable control element configured to receive user inputs for powering up or powering down the lamp assembly 102. That is, the power input element 718 can detect user actuation and transmit corresponding power control signals to the computing device 708 or power management circuitry within the lamp assembly 102. For example, the power input element 718 can include a pushbutton switch, a toggle switch, a slide switch, or a capacitive touch sensor that generates electrical signals when activated by a user. The power input element 718 can receive user inputs for powering up or powering down the bilingual augmented reality lamp assembly 102 by connecting or disconnecting electrical power from the battery 706 to the camera 202, the projector 204, the computing device 708, the speakers 704a, 704b, and other electronic components within the lamp assembly 102. In some implementations, the power input element 718 can be positioned on the bottom panel 702 separate from the selection input element 714, such that the power input element 718 provides a distinct control for turning the lamp assembly 102 on or off without affecting language selection or other operational settings accessible through the selection input element 714. The power input element 718 may transmit a signal to power management circuitry or the computing device 708 when activated, causing the lamp assembly 102 to enter an operational state in which the camera 202 begins capturing images, the projector 204 is activated for augmented reality projection, and the speakers 704a, 704b are activated to provide audio output. The power input element 718 may transmit a signal to the computing device 708 when activated while the lamp assembly 102 is in the operational state, causing the lamp assembly 102 to enter a low-power state or shutdown state that conserves battery charge by disconnecting power from the camera 202, the projector 204, and the speakers 704a, 704b. In some implementations, the power input element 718 can be implemented as a momentary switch that toggles power state with each activation, such that a first activation transitions the lamp assembly 102 from a powered-off state to a powered-on state and a second activation transitions the lamp assembly 102 from the powered-on state back to the powered-off state. The power input element 718 may be implemented as a latching switch that maintains a pressed state or an unpressed state corresponding to powered-on conditions or powered-off conditions, providing tactile feedback to users regarding the current power state of the lamp assembly 102 based on the physical position of the power input element 718.

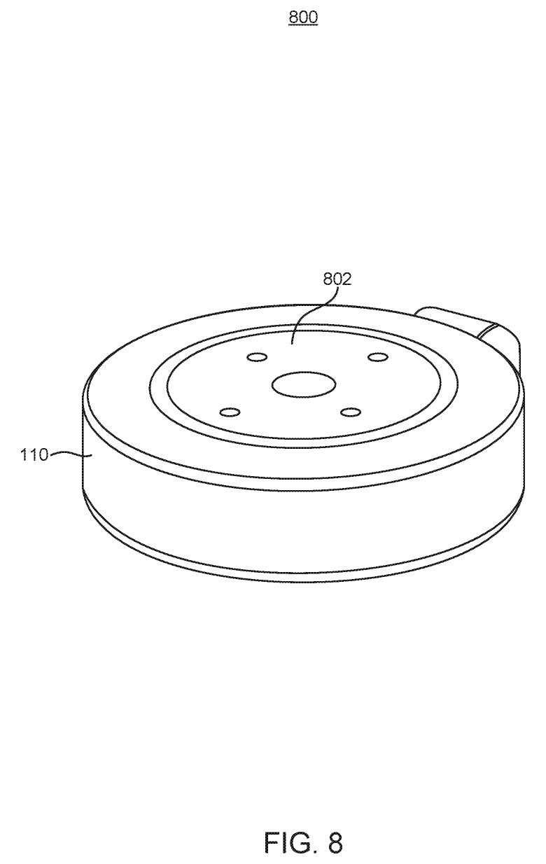

Referring now to FIG. 8, illustrated is a perspective view 800 of the control interface 110 of the bilingual augmented reality lamp assembly 102. The control interface 110 can include input elements 802.

The input elements 802 can be user-operable control components positioned on a surface of the control interface 110 and configured to receive physical inputs from users. That is, the input elements 802 can detect manual actuation by users and generate corresponding electrical signals transmitted to processing components of the lamp assembly 102. For example, the input elements 802 can include pushbutton switches, momentary contact switches, toggle switches, capacitive touch sensors, and/or tactile actuators that generate electrical signals when activated. The input elements 802 can receive user inputs for powering up or powering down the lamp assembly 102 and for switching between a plurality of languages for output, the plurality of languages comprising at least a first language, a second language, and a third language. In some implementations, the input elements 802 can include a first input element for power control and a second separate input element for language selection, such that users can distinguish between power control and language switching functions through spatial separation and/or tactile differentiation of the input elements 802. The input elements 802 may transmit electrical signals through conductors routed from the control interface 110 to the computing device 708 and/or other processing components within the lamp head 104 and/or the reading surface 108, such that activation of the input elements 802 triggers corresponding state changes in the lamp assembly 102. The input elements 802 may be arranged in a symmetric pattern and/or an asymmetric pattern on a top surface of the control interface 110 to provide intuitive access and reduce the possibility of unintended activation, with each input element positioned to provide tactile feedback through mechanical displacement, audible clicks, and/or resistance when pressed by users.

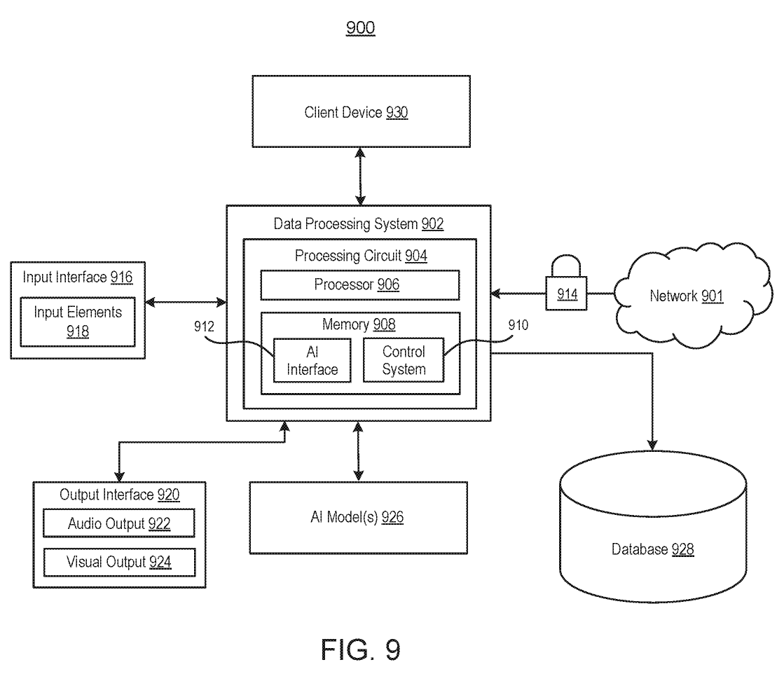

Referring now to FIG. 9, illustrated is a block diagram of a computing environment 900 for controlling an augmented reality lamp with bilingual language switching and audio/visual outputs. The computing environment 900 can include a data processing system 902, a network 901, a client device 930, AI model(s) 926, and a database 928. The data processing system 902 can include a processing circuit 904, an input interface 916, and an output interface 920. The processing circuit 904 can include a processor 906 and memory 908. The memory 908 can include a control system 910, an AI interface 912, and a security module 914. The input interface 916 can include input elements 918. The output interface 920 can include an audio output 922 and a visual output 924.

The computing environment 900 can include a data processing system 902. The data processing system 902 can be a computing device that executes processor-executable instructions to control operation of the bilingual augmented reality lamp assembly 102. That is, the data processing system 902 can execute stored program code to implement computational operations for identifying content on book pages, processing the content using language models, and generating audio signals and augmented reality projections. For example, the data processing system 902 can include the computing device 708 housed within the lamp head 104, or can include distributed processing components positioned in the lamp head 104 and the reading surface 108, or can include a separate computing device that communicates with the lamp assembly 102 via the network 901. The data processing system 902 can identify content included on a page of a book based on images captured by the camera 202, process the content using one or more models, determine that the content corresponds to textual content in a first language and/or visual content, and provide output comprising audio signals and/or augmented reality projections. In some implementations, the data processing system 902 can locally process the content using optical character recognition and a language dictionary without transmitting data to external servers and/or networks, thereby preserving user privacy and avoiding latency associated with cloud-based translation services. The data processing system 902 may execute instructions stored in the memory 908 to implement the control system 910, the AI interface 912, and the security module 914, which collectively perform text recognition, translation, projection control, and anti-counterfeiting operations. The data processing system 902 may receive input signals from the input interface 916 and transmit output signals to the output interface 920 to provide synchronized audio narration and visual augmented reality projections in response to user interactions with the lamp assembly 102. In some implementations, the data processing system 902 can execute instructions that cause a camera to capture images at predetermined intervals, cause the processor 906 to extract textual content from the captured images using optical character recognition algorithms, and cause an output device to display augmented reality projections aligned with detected page boundaries within a predetermined time interval after image capture. The data processing system 902 may store intermediate processing results such as extracted text, translation data, and/or projection alignment parameters in the memory 908 during operation, and may retrieve such results from the memory 908 to generate subsequent outputs without repeating prior processing operations.

The computing environment 900 can include a network 901. The network 901 can be a communication infrastructure that transmits data between computing devices or components in the computing environment 900. For example, the network 901 can include a local area network, a wide area network, the Internet, a wireless network using Wi-Fi or Bluetooth protocols, or any combination of wired and/or wireless communication links that connect the data processing system 902 to the client device 930, the AI model(s) 926, and/or the database 928. The network 901 can transmit image data, translation requests, language content, and/or software updates between the data processing system 902 and external systems such as the client device 930 and/or the database 928. In some implementations, the network 901 can provide connectivity for variants of the lamp assembly 102 that include Wi-Fi and Bluetooth connectivity, allowing remote control via smartphone app and integration with voice assistants such as Alexa, Siri, and/or Google Assistant. The network 901 may implement encrypted communication protocols to secure transmission of software updates, language content, and/or configuration data, preventing unauthorized access and/or distribution of proprietary AI-driven AR software. The network 901 may be restricted from providing or receiving configurations (e.g., via a network lock that prevents network traffic) in implementations where the lamp assembly 102 operates in an offline mode with processing performed locally on the data processing system 902, such that no image data and/or reading data is transmitted to external servers to preserve user privacy and support child-safety design constraints.

The computing environment 900 can include a client device 930. The client device 930 can be a user-operated computing device that communicates with the data processing system 902 to provide remote control and/or configuration of the lamp assembly 102. That is, the client device 930 can transmit control commands to the data processing system 902 via the network 901 and can receive status information from the data processing system 902 via the network 901. For example, the client device 930 can include a smartphone, a tablet, a personal computer, and/or a wearable device that executes a mobile application and/or a web interface for controlling language settings, brightness settings, and/or color settings of the lamp assembly 102. The client device 930 can transmit control commands to the data processing system 902 via the network 901 to switch languages, adjust lighting parameters, and/or initiate software updates for the lamp assembly 102. In some implementations, the client device 930 can receive status information from the data processing system 902 indicating the current language selection, battery charge level, and/or operational state of the lamp assembly 102 and display such information through a graphical user interface on the client device 930. The client device 930 may establish a wireless connection with the data processing system 902 using Wi-Fi and/or Bluetooth communication protocols, allowing users to control the lamp assembly 102 from a distance without requiring physical interaction with the input elements 918. The client device 930 may transmit voice commands to the data processing system 902 when integrated with voice assistants, such that users can issue hands-free commands to change languages, pause narration, and/or adjust brightness without interacting with the client device 930 and/or the lamp assembly 102 directly. In some implementations, the client device 930 can execute a mobile application that displays augmented reality content (e.g., synchronized with the augmented reality projection 506 displayed by the projector 204) allowing users to view the augmented reality content on the client device 930 as the projected output. The client device 930 may transmit user interaction data to the data processing system 902, such as touch input, gesture input, and/or voice input received at the client device 930, which the data processing system 902 can process to modify the augmented reality projection 506, adjust audio narration, and/or change language selection.

The computing environment 900 can include AI model(s) 926. The AI model(s) 926 can be machine learning models and/or artificial intelligence algorithms that process images, recognize text, and generate translations and/or visual content for augmented reality projections. That is, the AI model(s) 926 can convert captured image data into machine-readable textual representations, translated output in one or more target languages, and/or visual content for projection onto book pages. For example, the AI model(s) 926 can include optical character recognition models, natural language processing models, neural network translation models, and/or image generation models that convert scanned book page images into textual data and translated output. The AI model(s) 926 can process content included on a page of a book to determine that the content corresponds to textual content in a first language and/or visual content, and can generate translations of the textual content in a second language and/or augmented reality projections of visual content. In some implementations, the AI model(s) 926 can scan printed text in a book placed under the lamp assembly 102, convert scanned images into text in real time, match recognized words with a bilingual dictionary, and generate translations, pronunciations, and/or visual cues. The AI model(s) 926 may be stored locally in the memory 908 of the data processing system 902 and executed by the processor 906 to perform text recognition operations and translation operations without requiring internet connectivity, thereby avoiding transmission of captured images and/or reading data to external servers. In some implementations, the AI model(s) 926 can include interactive learning algorithms that adjust augmented reality overlays and/or lighting based on user interaction detected through the microphone 716 and/or the input elements 918. The AI model(s) 926 may provide adaptive feedback such as confirming correct pronunciation when audio signals captured by the microphone 716 match reference pronunciations stored in the database 928. The AI model(s) 926 may learn user preferences over time, such as frequently used languages and/or difficulty levels, by storing interaction history data in the memory 908 and adjusting subsequent augmented reality projections and/or audio outputs based on the stored interaction history data.

The computing environment 900 can include a database 928. The database 928 can be a data storage system that stores language dictionaries, visual assets, and/or software components accessed by the data processing system 902 during operation of the lamp assembly 102. That is, the database 928 can maintain structured data collections retrieved by the data processing system 902 to support text recognition, translation, and augmented reality projection operations. For example, the database 928 can include a relational database, a key-value store, a file system, and/or a cloud storage service that maintains bilingual dictionaries, translations, pronunciations, pre-stored visual assets, and/or AI-generated visual assets used for augmented reality projections. The database 928 can store language content for multiple languages such as English, French, and/or Spanish, and can provide translation data to the data processing system 902 when processing textual content captured from book pages. In some implementations, the database 928 can store identifiers of books determined by scanning QR codes and/or barcodes on books, and the data processing system 902 can access translations of textual content in a second language from the database 928 based on the identifier of the book. The database 928 may be located locally within the memory 908 of the data processing system 902 in offline implementations, such that the data processing system 902 can access stored language dictionaries and visual assets without requiring connectivity to external systems via the network 901. The database 928 may be accessed remotely via the network 901 in implementations that provide connectivity for software updates and/or content expansion, such that the data processing system 902 can retrieve updated language content and/or visual assets from remote storage systems through communication over the network 901. The database 928 may store visual assets such as scans of book illustrations, AI-generated images, and/or stock representations corresponding to entities described in book content, which can be retrieved by the data processing system 902 and projected by the projector 204 as animated augmented reality content that includes motion corresponding to actions described in the book. In some implementations, the database 928 can store entries that associate book identifiers with corresponding translation data, visual asset identifiers, and/or augmented reality content parameters, such that the data processing system 902 can retrieve translation data and visual assets specific to a particular book by querying the database 928 using the book identifier detected from a QR code and/or barcode scanned by the camera 202. The database 928 may store pronunciation data for words in multiple languages, which can be retrieved by the data processing system 902 and used to generate audio signals through the audio output 922 to provide pronunciation support during bilingual reading operations.

The data processing system 902 can include a processing circuit 904. The processing circuit 904 can be an electronic circuit that executes processor-executable instructions to implement computational operations for the data processing system 902. That is, the processing circuit 904 can fetch instructions from the memory 908, decode the instructions, and execute the instructions to perform operations related to image capture, optical character recognition, language translation, augmented reality projection control, and audio output. For example, the processing circuit 904 can include one or more central processing units, graphical processing units, application-specific integrated circuits, field-programmable gate arrays, and/or system-on-chip devices that execute instructions stored in the memory 908 to process images, recognize text, generate translations, and control augmented reality projections. The processing circuit 904 can identify content included on a page of a book based on images captured by the camera 202, process the content using the AI model(s) 926, determine that the content corresponds to textual content in a first language and/or visual content, and provide output through the output interface 920. In some implementations, the processing circuit 904 can execute optical character recognition algorithms to extract textual content from images captured by the camera 202, match recognized words with bilingual dictionaries stored in the database 928, and generate translations in a selected target language without requiring external network connectivity. The processing circuit 904 can receive input signals from the input interface 916 indicating user activation of the power input element 718 and/or the selection input element 714, and execute corresponding control operations such as powering up the lamp assembly 102 and/or switching between languages for audio and visual output. The processing circuit 904 can transmit control signals to the output interface 920 to cause the audio output 922 to provide audio narration of textual content in a selected language and cause the visual output 924 to project augmented reality content aligned with the physical layout of book pages captured by the camera 202. In some implementations, the processing circuit 904 can execute instructions that cause a camera to capture images at predetermined intervals, cause the processor 906 to extract textual content from the captured images using optical character recognition algorithms, and cause the output interface 920 to display augmented reality projections aligned with detected page boundaries within a predetermined time interval after image capture. The processing circuit 904 can store intermediate processing results such as extracted text, translation data, and/or projection alignment parameters in the memory 908 during operation, and can retrieve such results from the memory 908 to generate subsequent outputs.

The data processing system 902 can include an input interface 916. The input interface 916 can be a hardware interface, a software interface, or a combination thereof that receives input signals from users or input devices and transmits such signals to the processing circuit 904 for processing. That is, the input interface 916 can accept user inputs, sensor inputs, or commands originating from external sources and convert such inputs into data structures or control signals interpretable by the processor 906. For example, the input interface 916 can include electrical connections, signal conditioning circuits, analog-to-digital converters, or input processing software that receives signals from the input elements 918 and converts such signals into data structures or commands interpretable by the processor 906. The input interface 916 can receive input signals from the input elements 918 indicating user activation of buttons, switches, or touch sensors, and transmit corresponding commands to the processing circuit 904 to execute power control, language selection, or other operational functions. In some implementations, the input interface 916 can receive voice command data from the microphone 716, which is processed by the processing circuit 904 to detect spoken commands for controlling language settings, playback operations, or interaction with projected augmented reality content. In some implementations, the input interface 916 can receive touch input, gesture input, or proximity sensing signals from sensors integrated into the lamp head 104 or the reading surface 108, allowing users to interact with projected augmented reality content through physical movements detected by such sensors. The input interface 916 can receive image data from the camera 202 and transmit the image data to the processing circuit 904 for optical character recognition, content identification, and translation operations. In some implementations, the input interface 916 can receive electrical signals from the power input element 718 and the selection input element 714, and transmit corresponding control signals to the control system 910 within the memory 908. The control system 910 can interpret the input data and determine appropriate control actions such as switching languages, adjusting brightness, pausing narration, or initiating page-turn prompts based on the received input signals. The input interface 916 can include signal multiplexing circuitry that allows the processing circuit 904 to receive input signals from multiple sources simultaneously, such that image data from the camera 202, audio data from the microphone 716, and user inputs from the input elements 918 can be processed concurrently.

The data processing system 902 can include an output interface 920. The output interface 920 can be a hardware interface, a software interface, or a combination thereof that transmits output signals from the processing circuit 904 to output devices that provide audio and/or visual feedback to users. That is, the output interface 920 can convert data generated by the processor 906 into electrical signals, optical signals, and/or data packets suitable for transmission to the audio output 922 and/or the visual output 924. For example, the output interface 920 can include electrical connections, digital-to-analog converters, signal amplifiers, pulse-width modulation circuits, interface controllers, communication transceivers, and/or output processing software that converts data from the processor 906 into electrical signals suitable for driving the audio output 922 and/or the visual output 924. The output interface 920 can transmit audio signals to the audio output 922 to provide narration of textual content in a selected language and transmit projection data to the visual output 924 to display augmented reality projections on book pages. In some implementations, the output interface 920 can receive output data from the AI interface 912 that includes translated text, audio narration waveforms, and/or augmented reality visual content, and convert such data into electrical signals transmitted to the speakers 704a, 704b and the projector 204. The output interface 920 can synchronize audio output signals and visual output signals such that audio narration of a line of textual content is provided simultaneously with projection of augmented reality content associated with that line, creating a coordinated bilingual learning experience. In some implementations, the output interface 920 can adjust audio volume, projection brightness, and/or projection alignment parameters based on control signals from the control system 910, allowing dynamic modification of output characteristics in response to user preferences, ambient lighting conditions, and/or detected page boundaries captured by the camera 202. The output interface 920 can transmit control signals to the audio output 922 to modulate audio volume levels based on ambient noise measurements obtained from the microphone 716 and/or user volume preference settings stored in the memory 908. The output interface 920 can transmit projection control parameters to the visual output 924 to adjust keystone correction coefficients, focus settings, and/or brightness levels based on page geometry data and/or ambient illumination data determined by the AI interface 912. In some implementations, the output interface 920 can buffer output data in temporary storage locations within the memory 908 to maintain synchronization between audio narration and visual projection when processing latency varies across different processing operations performed by the processor 906. The output interface 920 can transmit timing signals to the audio output 922 and the visual output 924 to coordinate playback such that audio narration begins at a predetermined time offset relative to display of corresponding augmented reality projections on the book page.

The processing circuit 904 can include a processor 906. The processor 906 can be a central processing unit or other computational device that executes processor-executable instructions stored in the memory 908 to implement operations of the data processing system 902. That is, the processor 906 can retrieve program code from the memory 908, decode the program code, and execute the program code to perform operations related to image capture, optical character recognition, language translation, augmented reality projection control, and audio output. For example, the processor 906 can include one or more microprocessors, microcontrollers, digital signal processors, or application-specific processors that fetch instructions from the memory 908, decode the instructions, and execute the instructions to perform computational operations. The processor 906 can execute instructions implementing the control system 910, the AI interface 912, and the security module 914 to identify content on book pages, process the content using the AI model(s) 926, and generate audio and visual output through the output interface 920. In some implementations, the processor 906 can execute optical character recognition algorithms to extract textual content from images captured by the camera 202, execute translation algorithms to convert the extracted text from a first language to a second language, and execute projection alignment algorithms to align augmented reality projections with detected page boundaries. The processor 906 can receive image data from the camera 202 through the input interface 916, execute optical character recognition operations on the image data to extract textual content, and transmit the extracted textual content to translation algorithms that convert the textual content from the first language to the second language. The processor 906 can execute projection alignment algorithms that detect boundaries of book pages from the images captured by the camera 202, calculate geometric transformations to align augmented reality projections within the detected boundaries, and generate projection control parameters for transmission to the projector 204 through the output interface 920. The processor 906 may execute instructions stored in the memory 908 to implement interactive learning algorithms that adjust augmented reality overlays and lighting based on user interaction, provide adaptive feedback such as confirming correct pronunciation, and learn user preferences over time. The processor 906 can detect user interaction through audio signals captured by the microphone 716, compare the audio signals against reference pronunciation data stored in the database 928, and generate adaptive feedback audio signals through the audio output 922 to confirm correct pronunciation or provide correction guidance. The processor 906 may access the AI model(s) 926 stored in the memory 908 or retrieved from the database 928, execute inference operations using the AI model(s) 926 to generate translations or visual content, and transmit results to the output interface 920 for presentation through the audio output 922 and the visual output 924. The processor 906 can load the AI model(s) 926 from the memory 908 into working memory regions, execute inference operations using input data derived from the images captured by the camera 202, and generate output data that includes translated text, audio narration waveforms, and augmented reality visual content for transmission to the output interface 920.

The processing circuit 904 can include memory 908. The memory 908 can be one or more data storage devices that store processor-executable instructions, operating system software, application software, and data accessed or generated by the processor 906. That is, the memory 908 can maintain program code and data structures in volatile and/or non-volatile storage media that the processor 906 retrieves during execution of operations for the lamp assembly 102. For example, the memory 908 can include random access memory, read-only memory, flash memory, solid-state drives, or other volatile or non-volatile storage media that provide high-speed access to instructions and data during execution by the processor 906. The memory 908 can store the control system 910, the AI interface 912, and the security module 914, which are executed by the processor 906 to implement optical character recognition, translation, projection control, and security operations for the lamp assembly 102. In some implementations, the memory 908 can store the AI model(s) 926 locally, such that the processor 906 can execute the AI model(s) 926 to process content captured from book pages without transmitting data to external servers or requiring internet connectivity. The memory 908 can store bilingual dictionaries, language models, and visual assets in non-volatile storage sections. The memory 908 can store captured image data, extracted text, translation results, and projection control parameters in volatile storage sections during operation of the lamp assembly 102. In some implementations, the memory 908 can receive software updates or language content updates through the charging port 712 or the network 901. The software updates and language content updates can be written to non-volatile storage sections to expand language support or enhance functionality of the lamp assembly 102 while maintaining the ability to operate offline after updates are installed.

The memory 908 can include a control system 910. The control system 910 can be software instructions stored in the memory 908 and executed by the processor 906 to control operation of the lamp assembly 102. That is, the control system 910 can receive input signals from the input interface 916, execute control logic to interpret the input signals, and generate output signals transmitted through the output interface 920 to operate components of the lamp assembly 102. For example, the control system 910 can include executable program code that implements state transition logic, input processing routines, and output generation routines for controlling the camera 202, the projector 204, the speakers 704a, 704b, and/or the computing device 708. The control system 910 can receive user inputs from the input elements 918 to activate and/or deactivate the lamp assembly 102, switch between languages for audio output and/or visual output, and/or adjust lighting parameters such as brightness, color, and/or intensity. In some implementations, the control system 910 can receive voice commands from the microphone 716 and execute voice recognition algorithms to interpret the voice commands, such that users can control language settings, brightness, and/or playback without physically interacting with the input elements 918. In some implementations, the control system 910 can receive control commands from the client device 930 via the network 901, allowing users to remotely control the lamp assembly 102 through a mobile application and/or a web interface. The control system 910 may execute state machine logic that transitions the lamp assembly 102 between operational states such as powered-off, powered-on, reading in a first language, reading in a second language, paused, and/or page-turn prompting, based on input signals received from the input interface 916 and/or the client device 930. The control system 910 may maintain state variables in the memory 908 that indicate the current operational state of the lamp assembly 102, the currently selected language, and/or user preferences for brightness and/or color settings. The control system 910 may transmit control signals to the AI interface 912 to initiate image capture by the camera 202, trigger optical character recognition processing, select a target language for translation, and/or adjust adaptive learning parameters based on user interaction history stored in the memory 908. In some implementations, the control system 910 can receive signals from the power input element 718 and transition the lamp assembly 102 from a powered-off state to a powered-on state by allowing power distribution from the battery 706 to the camera 202, the projector 204, the computing device 708, and the speakers 704a, 704b. The control system 910 may receive signals from the selection input element 714 and execute language switching logic that cycles through available languages in a predetermined sequence, such that repeated activation of the selection input element 714 advances the selected language from a first language to a second language to a third language and back to the first language. The control system 910 may transmit output signals to the speakers 704a, 704b to provide audio feedback indicating the currently selected language when the selection input element 714 is activated, such that users receive audible confirmation of language changes.

The memory 908 can include an AI interface 912. The AI interface 912 can be software instructions stored in the memory 908 and executed by the processor 906 to coordinate execution of the AI model(s) 926 and processing of image data captured by the camera 202. That is, the AI interface 912 can receive image data from the camera 202 through the input interface 916, invoke the AI model(s) 926 to extract textual content and generate translations, and transmit results to the output interface 920 for presentation through the audio output 922 and the visual output 924. For example, the AI interface 912 can include application programming interfaces that define function calls for loading the AI model(s) 926 from the memory 908, data processing pipelines that transform image data into formats suitable for input to the AI model(s) 926, and/or model inference engines that execute the AI model(s) 926 using the transformed image data to produce output data such as extracted text, translations, and augmented reality visual content. The AI interface 912 can process content included on a page of a book using the AI model(s) 926 to perform optical character recognition on the captured images, match recognized words with entries in bilingual dictionaries stored in the database 928, generate translations of the recognized words in a selected language, and produce augmented reality projections aligned with the physical page layout detected from the captured images. In some implementations, the AI interface 912 can scan printed text in a book placed under the lamp assembly 102 by retrieving image data captured by the camera 202, convert the scanned images into textual data in real time by executing optical character recognition algorithms implemented in the AI model(s) 926, match recognized words with preloaded bilingual dictionaries stored in the database 928 by querying the database 928 with the recognized words, and generate translations, pronunciations, and visual cues based on the dictionary entries retrieved from the database 928 without requiring internet connectivity. The AI interface 912 may execute interactive learning algorithms that adjust augmented reality overlays and lighting based on user interaction detected through the microphone 716, provide adaptive feedback such as confirming correct pronunciation by comparing audio signals captured by the microphone 716 against reference pronunciation data stored in the database 928, and learn user preferences over time such as frequently used languages and/or difficulty levels by storing interaction history data in the memory 908 and modifying subsequent translation selections and augmented reality projection parameters based on the stored interaction history data. The AI interface 912 may execute projection alignment algorithms that detect boundaries of book pages based on images captured by the camera 202 by applying edge detection algorithms to identify perimeter contours of the pages, calculate geometric transformations to align augmented reality projections within the detected boundaries by computing keystone correction coefficients and scaling factors based on the detected page geometry, and transmit projection control parameters to the projector 204 through the output interface 920 to maintain accurate alignment as pages are turned and/or as the lamp assembly 102 is repositioned. In some implementations, the AI interface 912 can receive translation requests from the control system 910 when the selection input element 714 is activated to switch languages, retrieve translation data corresponding to the newly selected language from the database 928, and generate audio signals and augmented reality projections in the selected language by executing the AI model(s) 926 using the retrieved translation data. The AI interface 912 may load the AI model(s) 926 from the memory 908 into working memory regions of the processor 906 during initialization of the lamp assembly 102, such that the AI model(s) 926 remain accessible for repeated execution without requiring reloading from non-volatile storage during operation. The AI interface 912 may buffer intermediate processing results such as extracted text and detected page boundaries in the memory 908 to avoid redundant processing operations when generating subsequent outputs for the same page of the book 402.

The memory 908 can include a security module 914. The security module 914 can be software instructions stored in the memory 908 and executed by the processor 906 to implement security operations for the lamp assembly 102. That is, the security module 914 can enforce access controls, prevent unauthorized access to stored data, and selectively activate and/or disable network connectivity based on operational requirements and/or user preferences. For example, the security module 914 can include executable program code that implements authentication routines, encryption algorithms, hardware identifier verification routines, and/or network access control logic to protect proprietary software, language content, and/or captured image data from unauthorized distribution and/or external access. The security module 914 can protect privacy of users by preventing transmission of captured images and/or reading data to external servers and/or networks when the lamp assembly 102 operates in an offline mode. In some implementations, the security module 914 can implement a network lock that restricts communication with the network 901 to prevent data transmission during operation of the lamp assembly 102, such that the camera 202 captures images, the processor 906 performs optical character recognition and translation, and the projector 204 displays augmented reality projections without transmitting data to external systems. The network lock can disable wireless communication interfaces such as Wi-Fi transceivers and/or Bluetooth transceivers, preventing the data processing system 902 from establishing connections to external networks and/or devices. The security module 914 may selectively activate network connectivity when software updates and/or language content updates are authorized by user inputs received through the input elements 918 and/or the client device 930, allowing the data processing system 902 to receive encrypted software updates and/or language dictionaries through the network 901 while maintaining network isolation during reading operations. In some implementations, the security module 914 can verify a unique hardware identifier associated with the lamp assembly 102 to prevent unauthorized use of proprietary software and/or language content, such that the processor 906 compares a stored hardware identifier with a hardware identifier read from non-volatile storage and/or a hardware component of the lamp assembly 102, and prevents execution of the control system 910 and/or the AI interface 912 when the hardware identifiers do not match. The security module 914 may implement encrypted communication protocols to protect transmission of software updates, language content, and/or configuration data received through the network 901 and/or the charging port 712, such that data received from external sources is decrypted using encryption keys stored in the memory 908 before being written to non-volatile storage and/or executed by the processor 906. The security module 914 can maintain a record of software versions and/or language content versions installed on the lamp assembly 102 in the memory 908, and can verify integrity of installed software by comparing hash values of executable code stored in the memory 908 against reference hash values received with software updates to detect tampering and/or corruption of the installed software.

The input interface 916 can include input elements 918. The input elements 918 can be user-operable control components that receive physical inputs from users and transmit corresponding electrical signals to the processing circuit 904. That is, the input elements 918 can detect manual actuation by users and generate electrical signals representing user commands for controlling operation of the lamp assembly 102. For example, the input elements 918 can include the power input element 718 and the selection input element 714, which receive user inputs for powering up or powering down the lamp assembly 102 and for switching between a plurality of languages for output. The input elements 918 can transmit electrical signals through conductors routed from the control interface 110 to the processing circuit 904 when users activate the input elements 918, such that the control system 910 can interpret the signals and execute corresponding control operations such as transitioning the lamp assembly 102 between power states and/or cycling through available languages. In some implementations, the input elements 918 can include pushbutton switches, toggle switches, slide switches, and/or capacitive touch sensors that generate electrical signals when activated by users. The input elements 918 may provide tactile feedback through mechanical displacement, audible clicks, and/or resistance when pressed by users, such that users can confirm successful activation of the input elements 918 without requiring visual confirmation. In some implementations, the input elements 918 can be positioned on the control interface 110 at locations accessible to users while the lamp assembly 102 is in an extended configuration and/or a folded configuration, allowing users to control the lamp assembly 102 without requiring repositioning of the lamp head 104 and/or the stem assembly 106.

The output interface 920 can include an audio output 922. The audio output 922 can be one or more electro-acoustic transducers that convert electrical audio signals from the output interface 920 into audible sound waves. That is, the audio output 922 can receive electrical signals representing audio content from the processor 906 and produce corresponding acoustic output propagating into the surrounding environment. For example, the audio output 922 can include the speakers 704a, 704b coupled to the lamp head 104, which produce sound output in response to audio signals generated by the processor 906 and transmitted through the output interface 920. The audio output 922 can provide audio signals comprising a translation of textual content in a second language as part of the output generated by the one or more processors of the lamp assembly 102. In some implementations, the audio output 922 can output audio narration of book content in a first language and/or a second language based on user selection received via the selection input element 714, with the audio synchronized to visual augmented reality projections displayed by the projector 204 through coordinated control by the output interface 920. The audio output 922 may provide audio feedback indicating the currently selected language by outputting an audio signal that announces the language name when a user activates the selection input element 714 to switch languages. In some implementations, the audio output 922 can provide pronunciation support by outputting audio narration that demonstrates correct pronunciation of words in the selected language. The audio output 922 may provide adaptive feedback such as confirming correct pronunciation when the microphone 716 captures audio of a user attempting to pronounce words during interactive learning operations. The audio output 922 can receive audio data from the processor 906 through electrical conductors routed within the lamp assembly 102, such that the processor 906 transmits digital audio samples and/or analog audio signals to drive the speakers 704a, 704b. In some implementations, the audio output 922 can operate in combination with a digital-to-analog converter within the output interface 920 that converts digital audio data from the processor 906 into analog electrical signals suitable for driving the speakers 704a, 704b. The audio output 922 may adjust audio volume levels based on control signals from the control system 910, allowing dynamic modification of sound pressure output in response to ambient noise conditions detected by the microphone 716 and/or user volume preference settings stored in the memory 908.

The output interface 920 can include a visual output 924. The visual output 924 can be an optical projection system that converts image data from the output interface 920 into visible projected images displayed on surfaces beneath the lamp assembly 102. That is, the visual output 924 can receive projection data from the processor 906 and generate corresponding optical projections onto physical surfaces positioned below the lamp head 104. For example, the visual output 924 can include the projector 204 coupled to the lamp head 104, which produces augmented reality projections on book pages in response to projection data generated by the processor 906 and transmitted through the output interface 920. The visual output 924 can project augmented reality projections of translated text and/or visual content in visual proximity to pages of books to provide bilingual learning experiences. In some implementations, the visual output 924 can display bilingual content such as text, educational material, symbols, and/or interactive games onto book pages in response to processing operations performed on images captured by the camera 202, with the projected content aligned to detected page boundaries through projection alignment algorithms executed by the AI interface 912. The visual output 924 can receive projection control parameters from the AI interface 912 that specify geometric transformations, keystone correction coefficients, and/or boundary coordinates for aligning projected content with physical page layouts detected from the images captured by the camera 202. In some implementations, the visual output 924 can project augmented reality content that includes animated representations of entities such as animals, people, and/or objects detected from the content 404 of book pages, with the projected animations including motion corresponding to actions described in the book content. The visual output 924 can retrieve pre-stored visual assets from the database 928 and/or receive AI-generated visual assets from the AI interface 912 for display as augmented reality projections that correspond to entities identified in the textual content 404. The visual output 924 can modulate projection brightness based on ambient lighting conditions detected by the camera 202 and/or a separate ambient light sensor coupled to the lamp head 104. The visual output 924 can adjust projection parameters such as focus, brightness, keystone correction, and/or color balance based on control signals from the output interface 920, which adapts the projected augmented reality content to ambient lighting conditions, page geometry, and/or user preferences specified through the input elements 918 and/or the client device 930. In some implementations, the visual output 924 can synchronize projection timing with audio output timing from the audio output 922, such that projected augmented reality content appears on the book page simultaneously with corresponding audio narration of translated text in the selected language. The visual output 924 can project first language projected text 504a and/or second language projected text 504b within detected page boundaries corresponding to the first projection boundary 502a and/or the second projection boundary 502b, such that translated text appears aligned with the physical layout of the book 402.

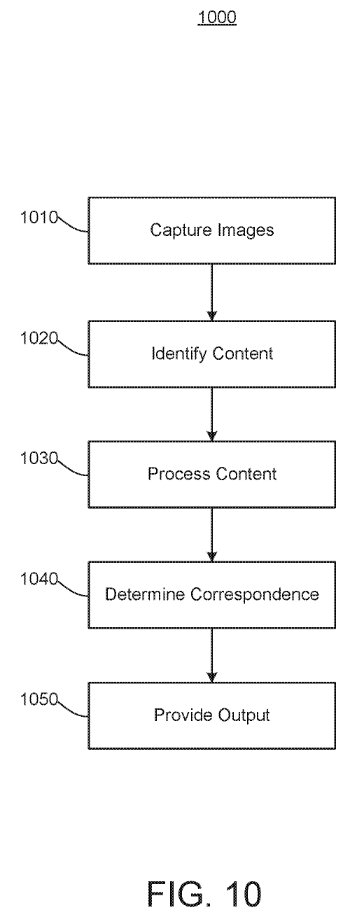

Referring now to FIG. 10, illustrated is a method 1000 for operating a bilingual augmented reality lamp assembly. The method 1000 can be executed, performed, or otherwise carried out by any of the computing systems or devices described herein. In brief overview of the method 1000, the method 1000 can include capturing images (step 1010), identifying content (step 1020), processing content (step 1030), determining correspondence (step 1040), and providing output (step 1050).

The method 1000 can include capturing images at step 1010. The images can be captured by the camera 202 coupled to the lamp head 104 of the bilingual augmented reality lamp assembly 102. The camera 202 can capture images of a page of a book placed beneath the lamp assembly 102 to obtain visual data representing content printed on the page. For example, the camera 202 may capture a series of images as a user positions the lamp assembly 102 over different pages of a book, with each captured image including textual content, illustrations, and/or other visual elements printed on the page. The images can be captured when the lamp assembly 102 is powered on and the lamp head 104 is positioned above the reading surface 108 with a book placed beneath the camera 202. In some implementations, the images may be captured continuously at predetermined intervals as the user reads through the book. In some implementations, the images may be captured in response to detection of page-turning events and/or user inputs indicating readiness to process a new page. The camera 202 can capture images by exposing an image sensor to light reflected from the book page, converting the light into electrical signals representing pixel data, and transmitting the image data to the one or more processors of the computing device 708 for subsequent processing operations. The captured images may be stored temporarily in the memory 908 as raw image data. In some implementations, the captured images may be preprocessed to adjust exposure, correct distortion, and/or enhance contrast before being transmitted to optical character recognition algorithms for text extraction.

The method 1000 can include identifying content at step 1020. The content can be identified by the one or more processors of the bilingual augmented reality lamp assembly 102. The one or more processors can identify, based on the images captured by the camera 202, content included on the page of the book 402. That is, the one or more processors can execute image processing algorithms that detect regions within the captured images corresponding to textual content and/or visual content printed on the page of the book 402. For example, the one or more processors may execute edge detection algorithms, contour detection algorithms, and/or segmentation algorithms that partition the captured images into text regions, illustration regions, and/or background regions based on pixel intensity values, color distributions, and/or spatial arrangements of visual features within the captured images. The content can be identified after the images are captured in step 1010 and transmitted to the one or more processors through the input interface 916. In some implementations, the content may be identified in real time as each image is captured by the camera 202, such that optical character recognition processing begins immediately upon receipt of image data from the camera 202 without waiting for multiple pages to be captured. In some implementations, the one or more processors can identify the content by executing optical character recognition algorithms that scan pixel data of the captured images, detect boundaries of individual text characters and/or words by applying pattern recognition models to the pixel data, and convert the visual representation of text into machine-readable text data stored in the memory 908. The one or more processors can identify textual content such as words, sentences, and/or paragraphs printed on the page of the book 402, and can identify visual content such as illustrations, photographs, diagrams, and/or decorative elements printed on the page of the book 402. In some implementations, the one or more processors can extract regions of the captured images corresponding to the identified visual content and store such regions in the memory 908 for use in generating augmented reality projections that correspond to the visual elements depicted in the book 402.

The method 1000 can include processing content at step 1030. The content can be processed by the one or more processors of the bilingual augmented reality lamp assembly 102. The one or more processors can process the content using one or more models to extract textual information, generate translations, and/or produce augmented reality visual content. That is, the one or more processors can execute algorithms that convert identified content into translated text representations, pronunciation data, and/or visual assets for projection onto book pages. For example, the one or more processors can apply language models, translation models, and/or image generation models stored locally in the memory 908 to convert the identified textual content from a first language into a second language and generate visual representations of entities described in the text. The content can be processed after the content is identified in step 1020 and before determining correspondence in step 1040. In some implementations, the processing can occur continuously as content is identified, such that translation operations and visual generation operations are performed in parallel with ongoing image capture operations and text extraction operations to reduce latency between page capture and output presentation. The one or more processors can process the content by executing optical character recognition algorithms to extract textual data from the identified text regions, matching recognized words with entries in a language dictionary stored in the memory 908, and generating translations, pronunciations, and/or visual cues based on the matched dictionary entries. In some implementations, the processing operations can include executing projection alignment algorithms that detect boundaries of the book page from the captured images, calculate geometric transformations to align augmented reality content with the physical page layout, and generate projection control parameters for accurate display of translated text and/or visual content within the page boundaries. The one or more processors can retrieve pre-stored visual assets from the database 928 corresponding to entities identified in the textual content, and/or can generate AI-generated visual assets using the AI model(s) 926 based on descriptions of entities detected in the textual content. In some implementations, the one or more processors can detect entities such as animals, people, and/or objects from the content 404, identify actions performed by such entities as described in the text, and generate augmented reality projections that include motion corresponding to the detected actions.

The method 1000 can include determining correspondence at step 1040. The correspondence can be determined by the one or more processors of the bilingual augmented reality lamp assembly 102. The one or more processors can determine, based on the one or more models, that the content corresponds to at least one of textual content in a first language or visual content. That is, the one or more processors can execute classification algorithms that assign a content type label to the identified content based on output from the one or more models. For example, the one or more processors may classify the processed content as textual content written in English, French, or Spanish, or as visual content such as illustrations of animals, people, or objects, based on analysis performed by the one or more models. The correspondence can be determined after the content is processed in step 1030 and before providing output in step 1050. In some implementations, the determination may be performed in real time as the one or more models complete processing of each line or section of the page, such that the one or more processors identify the language and content type progressively as the content is processed line-by-line. The one or more processors can determine the correspondence by executing language detection algorithms that analyze the textual data extracted during processing, comparing the textual patterns against known language models to identify the first language, and determining whether the content includes visual elements by detecting illustration regions or image data within the captured page images. The one or more processors can extract feature vectors from the textual data and compare the feature vectors against reference feature vectors stored in the memory 908 for each language in the plurality of languages, such that the language detection algorithms identify the first language based on feature similarity scores computed between the extracted feature vectors and the reference feature vectors. In some implementations, the one or more processors can detect entities such as animals, people, or objects from the content 404, and can identify actions being performed by such entities as described in the text, which can be used to generate augmented reality projections that include motion corresponding to the detected actions. The one or more processors can execute entity recognition algorithms that parse the textual data to extract noun phrases corresponding to entities, and can execute action detection algorithms that parse verb phrases to identify actions associated with the extracted noun phrases, such that the one or more processors can generate motion parameters for the augmented reality projection 506 based on the identified actions.

The method 1000 can include providing output at step 1050. The output can be provided by the at least one output device of the bilingual augmented reality lamp assembly 102. The one or more processors can provide, using the at least one output device, an output comprising at least one of audio signals comprising a translation of the textual content in a second language or an augmented reality projection of the translation of the textual content in the second language or the visual content in visual proximity to the page of the book 402. That is, the one or more processors can transmit audio data to the speakers 704a, 704b and projection data to the projector 204 to deliver synchronized bilingual narration and visual content aligned with the physical page layout. For example, the one or more processors can cause the speakers 704a, 704b to output audio narration of the textual content translated into French while simultaneously causing the projector 204 to display augmented reality projections of the French translation and animated visual representations of entities described in the textual content onto the page of the book 402. The output can be provided after the correspondence is determined in step 1040 and the one or more processors have generated the translated content and augmented reality visual elements based on the processing operations performed in step 1030. In some implementations, the output can be provided line-by-line as the one or more processors process each line of the page, such that audio narration and visual projections are synchronized with the progression through the textual content to provide a coordinated reading experience. The one or more processors can process the content included on a line of the page by providing the audio signals corresponding to the textual content of the line of the page and projecting the augmented reality projection 506 associated with the line of the page within the detected boundaries of the page. The one or more processors can transmit audio signals to the speakers 704a, 704b that convert the signals into audible narration of the translated text in the selected second language, and can transmit projection data to the projector 204 that displays augmented reality content aligned with the physical layout of the page of the book 402 through geometric transformations calculated by the AI interface 912. In some implementations, the provision of output can include adjusting the audio signals and augmented reality projections in response to user inputs received via the input elements 918, such as switching from a first language to a second language, pausing narration, requesting repetition of a line, or receiving voice commands detected by the microphone 716 that modify the language selection or playback behavior. The one or more processors can detect user activation of the selection input element 714 and execute language switching logic that cycles through available languages in a predetermined sequence, and can cause the speakers 704a, 704b to provide an audio signal indicating the second language is selected for the output. The one or more processors can determine a user has completed reading of the page of the book 402 based on elapsed time since the last line of the page was narrated, and can provide a second output comprising audio signals prompting the user to turn the page of the book 402. In some implementations, the one or more processors can adjust audio volume levels transmitted to the speakers 704a, 704b based on ambient noise conditions detected by the microphone 716 and/or user volume preference settings stored in the memory 908, and can adjust projection brightness and/or keystone correction parameters transmitted to the projector 204 based on ambient lighting conditions detected by the camera 202 and/or page geometry data determined by the AI interface 912.

Although an example computing systems and environments are discussed herein, the subject matter including the operations described in this specification can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of this patent application. While aspects of this patent application have been described with reference to an exemplary embodiment, it is understood that the words which have been used herein are words of description and illustration, rather than words of limitation. Changes can be made, within the purview of the appended claims, as presently stated and as amended, without departing from the scope and spirit of this patent application in its aspects. Although aspects of this patent application have been described herein with reference to particular means, materials and embodiments, this patent application is not intended to be limited to the particulars disclosed herein; rather, this patent application extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can be performed by, and apparatuses can be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an aspect of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative aspects, it is apparent that the foregoing is illustrative and not limiting, having been presented by way of example. In particular, although many of the examples presented herein involve specific combinations of method operations or system elements, those operations and those elements can be combined in other ways to accomplish the same objectives. Operations, elements and features discussed in connection with one aspect are not intended to be excluded from a similar role in other aspects.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate aspects consisting of the items listed thereafter exclusively. In one aspect, the systems and methods described herein consist of one, each combination of more than one, or all of the described elements, operations, or components.

Any references to aspects or elements or operations of the systems and methods herein referred to in the singular may or can embrace aspects including a plurality of these elements, and any references in plural to any aspect or element or operation herein may embrace aspects including only a single element. References in the singular or plural form are not intended to limit the presently disclosed systems or methods, their components, operations, or elements to single or plural configurations. References to any operation or element being based on any information, operation or element can include aspects where the operation or element is based at least in part on any information, operation, or element.

Any aspect disclosed herein can be combined with any other aspect or example, and references to “an aspect,” “some aspects,” “one aspect” or the like are not necessarily mutually exclusive and are intended to indicate that a particular feature, structure, or characteristic described in connection with the aspect can be included in at least one aspect or example. Such terms as used herein are not necessarily all referring to the same aspect. Any aspect can be combined with any other aspect, inclusively or exclusively, in any manner consistent with the aspects disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and operations such as substitutions, changes and omissions can be made in the design, operating conditions and arrangement of the disclosed elements and operations without departing from the scope of this patent application.

What is claimed is:

1. A bilingual augmented reality lamp assembly for use with a book, comprising:
a lamp stem coupled to a reading surface, the reading surface configured to receive the book;
a lamp head coupled to the lamp stem and configured to be positioned above the reading surface;
a camera coupled to the lamp head and configured to capture images of a page of the book;
at least one output device;
one or more processors coupled with memory and configured to:
identify, based on the images captured by the camera, content included on the page of the book;
process the content using one or more models;
determine, based on the one or more models, the content corresponds to at least one of textual content in a first language or visual content; and
provide, using the at least one output device, an output comprising at least one of:
audio signals comprising a translation of the textual content in a second language; or
an augmented reality projection of the translation of the textual content in the second language or the visual content in visual proximity to the page of the book.

2. The bilingual augmented reality lamp assembly of claim 1, wherein the first language is different from the second language, and wherein the first language and the second language are selected from English, French, and Spanish.

3. The bilingual augmented reality lamp assembly of claim 1, wherein the at least one output device comprises a projector configured to project the augmented reality projection and a speaker configured to provide the audio signals comprising the translation of the textual content in the second language.

4. The bilingual augmented reality lamp assembly of claim 1, further comprising:
a first input element for powering up or powering down the bilingual augmented reality lamp assembly, and
a second input element for switching between a plurality of languages for the output, the plurality of languages comprising at least the first language, the second language, and a third language.

5. The bilingual augmented reality lamp assembly of claim 1, wherein the one or more processors locally process the content included on the page of the book using optical character recognition and a language dictionary.

6. The bilingual augmented reality lamp assembly of claim 1, further comprising:
a light source coupled to the lamp head, the light source configured to illuminate at least a portion of the page of the book; and
at least one input element configured to activate or deactivate the light source.

7. The bilingual augmented reality lamp assembly of claim 1, further comprising:
a battery configured to supply power to at least the camera, the at least one output device, and the one or more processors; and
a power supply input configured to provide electrical signals to charge the battery.

8. The bilingual augmented reality lamp assembly of claim 1, wherein the one or more processors are configured to:
provide, using the at least one output device, a first output comprising audio signals of the textual content in the first language; and
responsive at least in part to an input selecting the second language, provide, using the at least one output device, a second output comprising the audio signals of the textual content in the second language.

9. The bilingual augmented reality lamp assembly of claim 1, further comprising a microphone configured to receive voice commands from a user.

10. The bilingual augmented reality lamp assembly of claim 1, wherein the one or more processors are configured to:
provide, using the at least one output device, the content included on a line of the page by providing the audio signals corresponding to the textual content of the line of the page and projecting the augmented reality projection associated with the line of the page.

11. The bilingual augmented reality lamp assembly of claim 1, wherein the one or more processors are configured to:
determine a user has completed reading of the page of the book; and
provide a second output comprising audio signals prompting the user to turn the page of the book.

12. The bilingual augmented reality lamp assembly of claim 1, wherein the one or more processors are configured to:
detect boundaries of the page based on the images captured by the camera; and
align the augmented reality projection within the boundaries of the page.

13. The bilingual augmented reality lamp assembly of claim 1, wherein the one or more processors are configured to:
detect, using the camera, a machine‑readable code on at least a portion of the book;
determine an identifier of the book based on the machine‑readable code; and
access the translation of the textual content in the second language from a language dictionary based on the identifier of the book.

14. The bilingual augmented reality lamp assembly of claim 1, wherein the one or more processors are configured to protect privacy of a user by processing the content using the one or more models without transmitting or receiving data from an external network.

15. The bilingual augmented reality lamp assembly of claim 1, wherein the reading surface forms a portion of the bilingual augmented reality lamp assembly, and wherein the bilingual augmented reality lamp assembly is configurable between:
a folded configuration in which the lamp stem is folded; and
an extended configuration in which the lamp stem is extended.

16. The bilingual augmented reality lamp assembly of claim 1, wherein the reading surface is separate from the bilingual augmented reality lamp assembly, and wherein the bilingual augmented reality lamp assembly comprises a mechanical clip or clamp configured to secure the lamp stem and the lamp head to the reading surface.

17. The bilingual augmented reality lamp assembly of claim 1, wherein the one or more processors are configured to:
detect, from the content, at least one entity selected from animals, people, objects, wherein the content indicates the at least one entity performing an action; and
generate the augmented reality projection using the images captured from the page, a pre‑stored visual asset, or an AI‑generated visual asset, wherein the augmented reality projection includes motion corresponding to the action performed by the at least one entity.

18. The bilingual augmented reality lamp assembly of claim 1, wherein the one or more processors are configured to:
responsive to an input selecting the second language, cause the at least one output device to provide an audio signal indicating the second language is selected for the output.

19. A method, comprising:
capturing, by one or more processors, coupled with memory, using a camera coupled to a bilingual augmented reality lamp assembly, images of a page of a book positioned on a reading surface;
identifying, by the one or more processors, based on the images captured by the camera, content included on the page of the book;
processing, by the one or more processors, the content using one or more models;
determining, by the one or more processors, based on the one or more models, the content corresponds to at least one of textual content in a first language or visual content; and
providing, by the one or more processors, using at least one output device coupled to the bilingual augmented reality lamp assembly, an output comprising at least one of:
audio signals comprising a translation of the textual content in a second language; or
an augmented reality projection of the translation of the textual content in the second language or the visual content in visual proximity to the page of the book.

20. A non-transitory computer-readable storage medium (CRM) having one or more instructions stored thereon, the one or more instructions executable by one or more processors to:
capture, using a camera coupled to a bilingual augmented reality lamp assembly, images of a page of a book positioned on a reading surface;
identify, based on the images captured by the camera, content included on the page of the book;
process the content using one or more models;
determine, based on the one or more models, the content corresponds to at least one of textual content in a first language or visual content; and
provide, using at least one output device coupled to the bilingual augmented reality lamp assembly, an output comprising at least one of:
audio signals comprising a translation of the textual content in a second language; or
an augmented reality projection of the translation of the textual content in the second language or the visual content in visual proximity to the page of the book.
